(19) United States
(12) Patent Application Publication
(10) Pub. No.: US 2019/0065610 A1
(43) Pub. Date: Feb. 28, 2019

(54) APPARATUS FOR GENERATING PERSUASIVE RHETORIC

(71) Applicant: Ravneet Singh, Ft. Lauderdale, FL (US)

(72) Inventor: Ravneet Singh, Ft. Lauderdale, FL (US)

(21) Appl. No.: 16/109,647

(22) Filed: Aug. 22, 2018

Related U.S. Application Data
(60) Provisional application No. 62/548,841, filed on Aug. 22, 2017.

(51) Int. Cl. G06F 17/30; H04L 12/58; G06F 17/27

(52) U.S. Cl. CPC G06F 17/30867; G06F 15/18; G06F 17/2785; H04L 51/32

(57) ABSTRACT

An apparatus to generate persuasive rhetoric for a social media participant. The apparatus includes a processor, an input device, an output device, and a non-transitory storage medium. The non-transitory storage medium includes a proposed message read module, a lingo score module, a pulse score module, a tone score module, and a sentiment module. The proposed message read module reads a number of proposed messages from the input device. The lingo score module measures the linguistic lingo of each of the number of proposed messages based on the linguistic lingo of a number of previously published messages. The pulse score module measuring the frequency of the number of proposed messages with a rate of postings for the number of previously published messages. The tone score module measures a willingness attitude of the number of proposed messages. The sentiment module measures a direction and direction of the number of previously published messages. Current price of crypto in exchange platform (down arrow means is falling).

### TECHNICAL FIELD

The disclosure relates generally to an apparatus and method for generating persuasive rhetoric. Specifically, the disclosure relates to an apparatus for generating persuasive rhetoric using a number of social media networks.

### BACKGROUND

Social interactions allow individuals to adjust the interpretation of their messages based on clues from other individuals. Body language, facial expressions, and eye gaze are examples of physical clues on individuals. Reactions of groups of people can be interpreted by group reactions.

Computer managed social networks allow individuals to interact with other individuals in disparate locations without personal interaction. Such interactions, however, can lead to challenges in understanding the interpretation of a message. Reading the interpretation of a message can be measured by various metrics, such as likes, shares, or other types of interactions on a computer network.

Computer mediated communication, and more generally technology mediated communication is becoming a powerful influencer and is changing at a rapid rate due to new developments within modern technology like Artificial Intelligence (AI), machine learning and natural language processing. The field of computer mediated communication within linguistics is digital rhetoric and persuasiveness is required of all types of successful campaigns that are political, private, public and even peer-to-peer related.

Systems have been disclosed in the past for analysis of social media content; see for example, U.S. patent application Ser. No. 13/653,856 and any references cited by the '856 application. Sentiment analysis may be employed by some users of social media, but determining a preferred tone for engaging with an audience is still often hit-and-miss. Additionally, a system that effectively analyzes tone is still desired.

In a previously filed and associated patent by the same inventor for a method known as Eyardsigns, under application numbers PCT/US2007/063506 and WO2007103982A1, said inventor established a method for providing election and voter information that associated a personal identifier with at least a portion of the voter profile information, and one voting classification and a method for providing an election candidate with voter profile information and a plurality of voter profiles on a voter space database. The purpose of this invention is to build on the previous one by establishing a method to increase voter turnout and participation.

Many academic studies have shown the rate with which social media has influenced the world population with nearly 3 billion users on these social media platforms (SMP) by the end of 2020. The primary asset on these platforms is content.

### BRIEF SUMMARY

An apparatus to analyze and generate persuasive rhetoric for a social media participant and reward actual engagement is disclosed. The apparatus may include a processor, an input device, an output device, and a non-transitory storage medium. The input device may be communicatively connected to the processor. The input device may receive a number of proposed messages. The output device may be communicatively connected to the processor. The output device may inform a social media participant of a number of metrics regarding the number of proposed messages. The non-transitory storage medium may include a proposed message read module, a lingo score module, a pulse module, a tone score module, and a sentiment module. The lingo score module may measure the use of social media language in the number of proposed messages based on the lingo of a number of previously published messages. A pulse score module measures the frequency of posting the number of proposed messages relative to the posting rate for the number of previously published messages. A sentiment score module measures the intended direction for an emotional response to a message and the intensity of that emotion based on the number of previously published messages. A tone score module measures the willingness or intent of a follower to relay the messages of a leader. Dominant tone intensity is divided into emotional or language and there are seven types of emotion inherent in tone: anger, fear, sadness, joy, analytical, confident, and tentative.

A method for generating persuasive rhetoric for a social media participant is described that includes reading a number of proposed messages an input device, measuring a lingo of each of a number of proposed messages based on a lingo of a number of previously published messages, measuring a frequency of the number of proposed messages with a rate of postings for the number of previously published messages, measuring tone of a message based on a willingness attitude of the number of proposed messages, and measuring sentiment of a direction based on a number of previously published messages.

An apparatus to generate persuasive rhetoric for a producing speaker includes a processor, an input device, an output device, and a non-transitory storage medium. The input device receives a number of proposed messages in at least one format of audio, text, video, imagery, photos. The output device informs a producing speaker of a number of metrics regarding the number of proposed messages. The non-transitory storage medium includes a proposed message read module, a lingo score module, a pulse score module, a tone score module, and a sentiment module. The proposed message read module reads a number of proposed messages from the input device. The lingo score module measures the linguistic lingo of each of the number of proposed messages, including at least one of the following: emojis, hashtags, mentions, post urls, abbreviations, emoticons, emojis, capitalization and punctuation; based on a number of previously published messages. The pulse score module measures the frequency of the number of proposed messages over a period of time, with a rate of postings for the number of previously published messages. The tone includes type, intensity, category of tone, the tone score module measuring a willingness attitude of the number of proposed messages. The sentiment module measures direction, emotion, characteristics, and user information to determine a direction and direction of the number of previously published messages.

### BRIEF DESCRIPTION OF THE DRAWINGS

A more particular description of the invention briefly described above is made below and incorporated herein by reference. Several examples of the invention are depicted in drawings included with this application. These examples are presented to illustrate, but not restrict, the invention.

FIG. 1 illustrates an apparatus for generating persuasive rhetoric;

FIG. 2 illustrates a method for generating persuasive rhetoric;

FIG. 3 illustrates an apparatus for generating persuasive rhetoric;

FIG. 4 illustrates an interface for using a voter space currency;

FIG. 5 illustrates an interface for managing an apparatus for generating persuasive rhetoric;

FIG. 6 illustrates an example of an interface for generating persuasive rhetoric;

FIG. 7 illustrates an interface to allow social network users to express an opinion of a speaker;

FIG. 8 illustrate an interface to allow social network users to propagate an opinion request form;

FIG. 9 illustrates a social media home page for a message propagator;

FIG. 10 illustrates an interface for an apparatus to generate persuasive rhetoric;

FIG. 11 illustrates a pulse score generator;

FIG. 12 illustrates a sentiment score generator;

FIG. 13 illustrates a tone score registration page;

FIG. 14 illustrates a tone score generator;

FIG. 15 illustrates an expression interface for a social media user;

FIG. 16 illustrates an expression interface for a social media user;

FIG. 17 illustrates a process for creating a campaign or voting booth or persuasive rhetoric;

FIG. 18 depicts an interface showing a lingo analyzing tool.

### DETAILED DESCRIPTION

A detailed description of the claimed invention is provided below with reference to examples in the appended figures. Those of skill in the art may recognize that the components and steps of the invention as described by example in the figures below could be arranged and designed in a wide variety of different configurations, without departing from the substance of the claimed invention. Thus, the detailed description of the examples in the figures is merely representative of an example of the invention, and is not intended to limit the scope of the invention as claimed.

In some instances, numerical values are used to describe features such as spreading factors, output power, bandwidths, link budgets, data rates, and distances. Though precise numbers are used, one of skill in the art recognizes that small variations in the precisely stated values do not substantially alter the function of the feature being described. In some cases, a variation of up to 50% of the stated value does not alter the function of the feature. Thus, unless otherwise stated, precisely stated values should be read as the stated number, plus or minus a standard variation common and acceptable in the art.

For purposes of this disclosure, the modules refer to a combination of hardware and program instructions to perform a designated function. Each of the modules may include a processor and memory. The program instructions are stored in the memory, and cause the processor to execute the designated function of the modules. Additionally, a smartphone app and a corresponding computer system may be used to implement a module or a combination of modules. The storage medium refers to the app itself, the blockchain system, cryptocurrency exchange, the search and compliance engines and the information contained therein.

A purpose of the claimed apparatuses, methods, and systems is to generate persuasive rhetoric in a social media environment. Persuasive rhetoric refers to a measure of how effectively a user (leader) uses their social media voice (tone, sentiment, lingo and pulse) to convince listeners (followers) to participate in the dialogue published or shared by the leader based on follower engagement in the form of follower likes, replies and shares. A number of social media platforms are monitored to identify lingo, pulse, tone, sentiment. An aggregated score may be determined and used to predict the effect of a social media message.

As described above, social media is a method of communication that may restrict physical interaction.

The apparatus also consists of a blockchain-based cryptocurrency exchange, and social media networking application and system for online voting and campaigning. This application may allow users: (1) to register as a voter or campaigner; (2) to create a secure voting booth or campaign, or both, (3) to securely vote openly or anonymously; (4) to tally votes; (5) to securely collect and distribute voter information; (6) to associate with other voters, campaigners, campaigns and associations; and (7) to conduct voter outreach. The software may create a network that facilitates, stimulates and generates engagement among voters and campaigners on a social media platform specifically designed for voting and campaigning. The apparatus may operate on a blockchain-based system as a social media website and mobile application that enables users to connect, vote, campaign, create and share content, and to exchange cryptocurrency. The blockchain system may make voting, campaigning and cryptocurrency transactions transparent, secure and auditable without compromising voter privacy.

The apparatus may cost only a fraction of the current cost of traditional ballot-based voting and campaigning systems. This apparatus may be a user-friendly system that may increase the speed and accessibility of the voting process, which may increase voter turnout.

The apparatus may be provided as part of a technology such as a software-as-a-service (“SaaS”) platform that allows users or service providers to instantaneously access and maintain an account. The account may include the complete voting, campaigning, payment and account history for any given user with metadata intact. The system may use Artificial Intelligence algorithms to stimulate engagement based on a number of features. The software may have a search, eligibility and compliance engine to ensure that users comply with privacy policies and laws when campaigning or voting.

The apparatus may contain a payment and reward system in which users may redeem virtual money for increasing the actual engagement of others for a respective campaign, and redeem social media tokens for allowing other users to access and use their network to increase voter outreach. Users may have the option to communicate, associate or be associated with relevant users or campaigns, or both, via a recommender and engagement system that provides responsive notice, feedback about progress.

The invention may rely on a blockchain that may certify every vote, campaign and cryptocurrency exchange as a transaction. Blockchains may enable users to access and maintain a repository of all original and modified campaigning, voting, associational and cryptocurrency transactions on one social media platform. Blockchain may serve as the method that saves and certifies every transaction over a fair, transparent and decentralized peer-to-peer network.

Elections may be a prolific method of gauging the sentiment of a population. Elections may be used to select political leaders. Significant time and money may be spent to influence an election.

With the proliferation of social networking, parties that wish to influence elections or opinion are challenged by not being able to see their audience. Computer tokens have taken the place of body language to express opinions. Rather than an audience laughing, individuals may use emoticons or abbreviations to express emotions. The use of computer codes instead of body language may inhibit the flow of communication. Speakers who do not know how to use or interpret such computer codes and social media language (lingo) cannot communicate effectively or persuasively. The invention serves as a tool to help users generate the right persuasive language to use when communicating with followers or listeners so that they engage with the speaker or the content or both.

The apparatus, methods, and systems described may examine computer related codes, such as emoticons, reactions, shares, and comments to enable a user to better understand a targeted audience.

The apparatus may analyze persuasiveness in social media content as it relates to voting and campaigning on a social media platform. Persuasion is the measure of how effectively a user in the role of a speaker (leader) uses their social media voice, as measured by tone, sentiment, lingo and pulse, to convince another user in the role listener (follower) to participate in the dialogue published or shared by the speaker based on follower engagement in the form of follower likes, replies, comments, and shares.

Social media platform™, a social media platform, and its messages (posts) serve as an example to portray how the apparatus may operate. The apparatus may analyze the tone of social media content as it relates to voter outreach and engagement and may contain a cryptocurrency payment and reward system that rewards social media tokens to a user for allowing another user to use the latter's social media network to increase engagement, while actual engagement is also awarded alternative rewards.

It should be noted that any references to Voterspace also refer to the system or apparatus.

Today, the digital economy and the rise of the Internet of Things (IoT) has a vast distribution, social, economic, political influence on the psychology behavior of an immense part of the human population. IoT is a network of physical devices embedded with electronics that enable them to interconnect and exchange data over the internet. Even with IoTs, leaders may ineffectively engage in many social media platforms by paid, earned, or owned media creating undesirable “social media noise”. This invention allows users to engage other users effectively with an optimal social media voice.

Organizations may look at the analytics of the data of their audience to understand their return on investment (ROI), return on followers (ROF) or return on message (ROM). Each of these classifications creates a total engagement metric part of the social persuasion score and is in aggregate, a return on engagement (ROE). Post Conversation Rate (PCR) is the number of posts (p) divided by the number of comments (c) or PCR=p/c. Post Amplification rate (PAR) is the number of post divided by the number of reposts (rps) or PAR=p/rps. Applause Like Rate (ALR) is the number of posts divided by the number of favorites (hearts) (fv) or ALR=t/fv. The audience who responds or listens on Social media platform are called followers. Followers respond to the speaker and their tone, in at least three ways: emotionally, socially and languistically. The speaker of the message is a leader that a follower may follow on that social media platform. A leader who speaks with a tone in their style can produce a chain or pulse approach to reaching followers in their network based on the frequency with which they communicate. ROI, ROF, ROM, ROE are all metrics of SPS.

According to one example, a system for analyzing social media content is disclosed; the system may use various modules to generate a social persuasion score. The system may be used to analyze unpublished social media content, predict its persuasiveness, and provide suggestions or actual corrections to the content. The system may analyze tone, and provide suggestions for rewording content or for taking certain actions, or both, based on the tone of content.

Social media platforms may create decentralized communication that shifts control of information to followers. This is the social media leader's personality, or voice embraces a mental leadership model. That model is a centralized form of electronic communication (as Web sites for social networking and microblogging) through which users create online communities to share information, ideas, personal messages, and other content on a social media platform.

The leader may record his or her communication, such as posts, between at least two dynamic parties in a system that forms a feedback loop, which may include a leader, who may also be a writer, and a number of followers, who may also be a reader. Use of the apparatus may benefit a leader by increasing the leader's efficiency at using social media to achieve goals, variableness in presentation, and to help the leader permanently evolve as a leader. The apparatus may use an artificial intelligence engine or other type of module to assist a user in altering their tone when engaging with followers or the public on a social media platform; the apparatus may calculate an initial Social Persuasion Score (SPS) for a planned communication or published communication.

Social Persuasion Score (SPS) is an index based on a Social Media Voice (SMV) Algorithm ranging from −100 to 100, or a different set of numbers in tens such as −1000 to 1000 or 0 to 10 or -1 to 1. SPS is a proxy for gauging a message sender's overall influence on a receiver's engagement with the message over time. Voting power is based on SPS because if a campaigner's SPS is high, then a voter will more likely affirmatively vote for that campaigner's position in a given campaign and engage other potential voters to vote in the same manner. The Persuasion Score Accumulator may determine the total value of the interaction of content by each of these three nodes or one of the three nodes:
Writer=Reader
Speaker=Listener
Leader=Follower

SMV is the measure and direction in which a leader communicates information digitally across the world and in this new digital economy. A leader may have one SMV. A leader who posts content with SMV, using intentional tone, may increase engagement with followers. SMV may consists of the following variables: (1) tone; (2) sentiment; (3) lingo; and (4) pulse. SMV may refer to the creation of meaningful messages and message maps that direct a company in its interactions on SMPs. SMV may help users create engaging messages and message maps to direct a brand in interactions with followers across SMPs. Leaders and organizations that wish to prosper on social media platforms, or business in general, may need to showcase their brand by using a “natural” online voice. This may be because SMV may be comprised of understanding the brand persona first, then suitable message tone, and lastly the intended language necessary to communicate effectually in each post made on the social media.

Definitions of Input Independent and Dependent Variables, Control and device(s) used for the Social Media Voice Algorithm used to determine SPS:
1. (a) Tone: Tone or dominant tone intensity may be the manner and attitude in which a message is delivered to evoke a specific response from followers or listeners or simply, the willingness attitude of a speaker or leader. Tone intensity, which may be represented as T, may be a score ranging from 0 to 1 on 13 different categories of tone which are divided into three groups Emotional, Language and Social Personality. The system may take the sum of the dominant tone in each three subgroups. This may therefore yield a potential tone score of 0 to 3. Anything above 0.05 may be considered significant by the system. Dominant intensity may be the highest value from the range of 0 to 1. There may be at least seven types of tone that may be divided into two categories: emotional or language. Emotional tones may be (a) joy, (b) sadness, (c) anger, (d) fear. The language tones may be (e) analytical, (f) tentative, and (g) confident. Other tones may be added.
2. To help users enhance the persuasiveness of content, some embodiments may rely on an artificial intelligence engine such as the IBM Watson NLU, Sentiment Analyzer tool, which is a natural language understanding software that offers several application programming interface APIs for analysis of texts through a process known as natural language processing. IBM Watson™ is a computer system that answers questions and is capable of identifying a natural language's tone and sentiment. The IBM Watson™ NLU Sentiment analyzer tool is natural language understanding software that offers different application programming interface (APIs) for analysis of texts through a process known as natural language processing. Natural language processing uses AI and computational linguistics that maps the interaction between computers and human languages. Watson™ and NLU provide unique analyses of tone and sentiment. They may each have distinct algorithms to predict tone and sentiment accurately without confounding one another.
3. Some embodiments may use the model as a model to measure tone and sentiment because it demonstrated a high level of reliability and validity according to IBM scholarly research for quantifying other data. IBM Watson™ measures seven types of tone: (a) joy, (b) sadness, (c) anger, (d) fear, (e) analytical, (f) tentative, and (g) confident. These types are divided into two categories: (a) emotion, consists of joy, sadness, anger, and fear; and (b) language, which consists of analytical, tentative, and confident. Each type of tone comes with an intensity score ranging from 0 to 1. If a type of tone is not detected, the IBM tool will produce no score. The message will be given a score of 0 for that tone. If a message yields two or more types of tone, the highest value type of tone will be the dominant tone and will be used in later analyses.
4. (b) Sentiment:
5. (a) intensity: strength of text;
6. (b) polarity: whether a text is positive, negative, or neutral
7. Sentiment is the view, attitude, opinion or position taken toward a situation or event and can have a positive, negative, or neutral emotion. Sentiment may be positive, negative, or neutral. The intensity scale may range from −1 to +1. The direction of the sentiment is negative (a negative number indicates negative sentiment) and positive (a positive number indicates positive sentiment). The two variables for sentiment may be measured by intensity and direction. Sentiment may be calculated based on the number of total messages, minus the number of negative messages to give us a positive score or vice versa the total of number of posts, minus the positive to give us the negative sentiment. The dominant value may tell us the value and its difference is used in the equation. Net sentiment is the perception of whether the post is positive or negative. As represented above and further described in the text, the social persuasion score may be calculated by multiplying post frequency by engagement and tone, then this product may add the amount of reach. This value may then be multiplied by total volume and then divided by the mean value of the dominant sentiment. Followers and the leaders may have disagreeing sentiments, or sentiments that are at odds with each other which typically producing push or pull relationship. Sentiment analysis is the use of natural language processing to quantify attitudes about a certain topic.
8. (c) Lingo refers to language and linguistics, including the atypical practical social media language utilized by social media users to communicate on a social media platform. Lingo consist of the following components: (a) mentions, (b) hashtags, (c) abbreviations (RTs), (d) post links (URL), and (e) emojis; (0 emoticons; (g) capitalization and (h) punctuation. Each lingo variable may yield a score of 0 (does not appear in the post) or 1 (appears in the post). Lingo and pulse will be calculated with IBM SPSS, a software package for interactive or batched statistical analysis.

(d) Pulse: Pulse or social media pulse rate (SMR) is the average mean of the amount of time between posts in the social media feed and can be measured in hours or minutes. Burstiness is the transmission of data intermittently, in spurts, rather than a continuous stream. The formula for the coefficient of variation (CV) is:

Coefficient of variation=(standard deviation/mean)

in symbols: CV=(SD/X̅)

Therefore, each tweet within the same day maybe assigned the same coefficient variation score yielding the fourth independent variable, pulse. Changes in pulse per day may be used to examine associations of tweet engagement. The formula for this calculation may be as follows: coefficient of variation =(standard deviation of tweets per day/mean number of tweets per day).
9. The formula for pulse may be as follows:

$$CV day 1 = \frac{SD day 1}{\overline{X} day 1}$$

10. (e) Frequency: divide the amount of posts for a given message in a given day by 24. This may yield the average amount of posts posted during that specific 24 hour period. The 24 hours period is illustrative in nature, and does not restrict a time period that the system may operate on.

### Definition of Output Dependent Variables:

a. Engagement: Engagement (E) may be a measure of the response of the followers. This may be calculated by taking the sum of all likes, replies, comments, mentions or hashtags, votes and shares of an individual message over a specific time, divided by amount of followers. To increase engagement with SPS, a user must first understand and effectively use the linguistic taxonomy (lingo) of each social media platform. For example, on Twitter there are 15 types of tweets that a user would have to know how to use well. Second, a user needs to discover and introduce their brand or online social media personae. This is where a social “voice loop” may begin and the user can evaluate how she or her engages with the audience, reviews feedback and looks at the word of mouth (WoM) of responses based upon the content. Third, a user (leader) may need to leverage that self-expression and feedback loop in the form of his or her own engagement to get pure reciprocity of tone with followers. Engagement may cause persuasion because increased engagement tells a speaker that the SMV used was effective so the speaker just has to repeat that process. Examples of engagement in the invention include:
   i. (a) likes: likes of each specific post which shows a user's appreciation for that post.
   ii. (b) replies: a reply to another user's post or message using the reply icon
   iii. (c) comments, mentions or hashtags
   iv. (c) votes: an affirmative vote in favor of or against a campaign or candidate for a given voting booth.
   v. (d) shares: reposting of another user's post.

### Definition of Control:

a. Follower Growth: may refer to the number of followers who choose to follow another user account by clicking on the symbol or icon “Follow” button displayed on the user's account website or mobile application. Once this is clicked, it will change status to “Following” displaying an activation status of the relationship.

The apparatus may suggest a different planned communication with a different calculated SPS, referred to as the target SPS. The apparatus may automatically send the planned communication or replace a published communication with the planned communication; or in some embodiments, a human user may be required to confirm the suggested planned communication before the planned communication is submitted for publication at a social media platform such as Social media platform. For example, the apparatus may analyze a body of communications, such as published posts belonging to a single user's account, to determine a SPS, and then suggest a campaign with a plurality of proposed communications that may be generated to increase the likelihood of engagement. The frequency over time of communication, also referred to as a social media pulse, may be used to trigger persuasion that may evoke a sentiment of influence over the social media platform.

The apparatus may be a computer-based system that may provide a user interface to a user; the user may interact with the interface or in some embodiments the computer-based system automatically analyses and posts social media content and the user may view diagrams or visual representations of the analyses or proposed social media campaigns; based on the desired level of interaction between the user and the system, the system may then act automatically or wait for user input before implementing one or more social media campaigns. Users may select a desired tone or a target SPS, and the system may then generate content, responses, or other suggestions of the types of content, such as videos, and target tone for the other types of content, which may include suggestions on how to present a video that may be more likely to evoke a target SPS.

The system may measure the tone of social media content over time, as well as resultant SPS, persuasiveness, and sentiment. Advantages of the disclosed system may include predicting which tone should be used to increase follower engagement or to increase the persuasiveness of social media content to a known, unknown or targeted population.

The system may be used for assisting a social media leader, or someone who aspires to become a social media leader, with publishing social media content using an intentional tone that is more likely to be persuasive to the leader's followers.

The system may also use algorithms and calculations before performing actions or suggesting a course of action; some of the algorithms or calculations may use, search for, or attempt to influence a correlation between the number of followers who like and engage, such as by reposting, and a predicted social persuasion score, which may also be termed a social media persuasion score (SPS).

There may be a correlation between followers who like and repost, which may be termed engagement, which may generate a social media platform persuasion score that can be predicted.

The system, apparatus, or computer-implemented method may use quantitative methods or descriptive statistics. Descriptive statistics, for purposes of this disclosure, are brief descriptive coefficients that summarize a given data set, which can be either a representation of the entire population or a sample of it.

The following equation may be used by the system to calculate Social Persuasion Score (SPS):

(SPS)=((Content+Volume)÷(Population+[tone {engagement (frequency÷time)}]))÷Sentiment (Positive−Negative)

SPS may be calculated to report the amount of persuasion of individual posts. In order to calculate the SPS, volume which is represented as [Volume], may be calculated by summing the total amount of posts the user has posted up to the post being analyzed. Reach, which may be represented in the formula as R, is the amount of followers a user has at the current time the post is sent, divided by the total number of social media platform users during the same time.

Besides finding a tone, sentiment and lingo analysis, engagement metrics, time and frequency may be calculated to determine a social persuasion score of the data. The system may determine that tone is a separate and measurable metric from sentiment analysis.

The system may make the following assumptions. The leaders use of his tone increases persuasion with his followers. A leader's tone can predict the follower's engagement (RT & Likes) A leader's tone is directly correlated to the effectiveness of communication with his followers. Appropriate tone may increase sentiment analysis. Greater persuasion increases follower engagement. Lower persuasion decreases follower engagement.

For this disclosure as used in the present specification and in the appended claims the term “image,” used herein, refers to an electronic representation of a scene, object, or event.

As used in the present specification and in the appended claims, the term a number refers to one or more of an item; zero not being a number, but rather, the absence of a number.

As used in the present specification and in the appended claims, the term a plurality refers to two or more of an item.

As used in the present specification and in the appended, the term communication refers to the imparting or exchange of information.

As used in the present specification and in the appended, the term cryptocurrency refers to an encrypted, decentralized digital currency transferred and confirmed in a public ledger through mining or through the validation of a transaction. Specifically, cryptocurrency refers to a blockchain database of encrypted, digitally recorded data blocks of transactions stored across decentralized computer networks according to a pre-determined set of rules.

As used in the present specification and in the appended, the term social media leader refers to a social media leader is a user of social media with established credibility online in a specific cause, belief, principle, or organization. A social media leader has access to vast and influential followers. A social media leader engages these followers via a social media platform(s), which empowers the leader to amplify the popularity of his or her message. A social media leader has the power to persuade these followers by their dynamic engagement of their personal/professional tone: emotional, social, and language.

As used in the present specification and in the appended, the term Social media platformism refers to a brief character based statement in the form of opinion, declaration, remark or utterance made by a social media leader; in the shape of a post on the social media platform/online message service called Social media platform™; to followers who decision-making to engage are influenced and/or persuaded by the social media leaders emotional, social, or language tone.

As used in the present specification and in the appended, the term social media-ocracy refers to a philosophy that the society that governs us, is the rule of freedom, for followers to express themselves in speech and the rule of the majority followers to engage independently without the impact of prejudice by a virtuous leader.

As used in the present specification and in the appended, the term social persuasion score (SPS) refers to an index ranging from −100 to 100, or a different set of numbers such as −1000 to 1000 or 0 to 10 or −1 to 1, that measures the willingness of one or more followers to be persuaded by a leader. The SPS is a proxy for gauging of the senders overall influence on a receiver's engagement with the frequency over time with the message.

As used in the present specification and in the appended, the term Social Media Pulse (SMP) refers to the rate at which a user sends their social media message to their intended audience so that it resonates with their intended audience. Common persuasion techniques include: (1) reciprocity; (2) consistency and commitment; (3) social proof (assuming the actions of others in an effort to show the correct action or behavior to take in a given situation); (4) authority; (5) liking; (6) and scarcity. Pulse is usually called social media rate (SMR), which is the number of times messages are sent each minute (tpm). Effective persuasion relies on using the right convincing language and linguistic structure in a conversation to convey information to elicit a specific response. Influence is the power to change or affect a person and the ability to command or force that effect.

The rhythm in which content is presented allows users to be in sync with followers for messages that are weak or strong and is a simple way to see if the writer is in beat with the reader. Burstiness the intermittent increase or decrease in the speaker's frequency or activity of communicating content to listeners within a given time.

As used in the present specification and in the appended, the term tone refers to the expression or implication of a speaker's emotional state about the subject matter of a communication, that is, the speaker or leader's willingness to elicit a certain response from listeners or followers. Tone may be emotional or language-based. On that basis, the IBM Watson Tone Analyzer will measure seven types of tone for this invention: (a) joy, (b) sadness, (c) anger, (d) fear, (e) analytical, (f) tentative, and (g) confident. This is a major distinction of someone who is a social media leader (digital user or participant) and someone who is not. When leaders engage with tone they are able to use content or their language to social and emotionally connect with their writers. The tone of the leader allows them to help influence the sentiment and empower the listener. When combined, tone and sentiment allow a social media leader to build a strong tie with a follower, which in turn, can inspire follower engagement and action. In any social media network the theory revolves around the effectiveness of the relationship. When a leader uses his attitude in his own voice in the message they can and may be more persuasive to their follower then a third party agency, campaign manager, marketing department, intern, or someone who does not represent the same credibility of the leader. Leaders who embrace tone are more affective in their communication and their content enhances the behavioral action of both the leader and the follower. Tone is a tactical multiplier for engagement that can enhance the strength in which a message is delivered or distributed. Influential marketing is created by sentiment and popularity of the account. The sentiment can be negative, positive, or neutral. Persuasiveness, or persuasiveness scores, can be negative, positive, or neutral. The sentiment can be negatively persuasive, positively persuasive, or neutrally persuasive.

Understanding the Formula of Persuasion. The impact of tone on the social media platform account may be a factor for measuring the persuasion of the content being sent by a leader to a follower. In return, how the follower engages may determine the sentiment of the follower's reaction, as measured by the degree to which the followers redistribute the leader's social media content or to the degree at which followers add their own content to the leader's published content which may result in the followers influencing the leader's published content. (A tone score multiplied by an engagement score)/(sentiment value)=a persuasion formula value. When tone=t, engagement=e, sentiment=s, and persuasion=P, then the simplest way to determine persuasion may be the value of the {(t×e)/s}=P.

Key performance indicators (KPIs) of a social media leader's engagement with followers may be used to calculate that leader's communication performance by measuring and assigning values to the participation or engagement with the followers. These analytics may give insight on the speaker's message. Persuasion, however, whether persuasion is positive negative or neutral, may be a result of sentiment. So, the factors that may influence the content may only be measured after it has been delivered and engaged in persuasively. So, a user may identify the type of content or as an example, the type of post. Then, a user may understand what is measurable between the leader and the follower. Engagement may add to the formula's value to quantify an interaction on each type of call to action of persuasion that a leader wishes to make.

Social media leader “call to action” engagement may occur when a follower interacts with a leaders' content in such a way that it produces metrics. That engagement could create awareness, generate demand, driver adoption, interact with followers, and inspire evangelism for content. The content that is written may be termed the social media strategy, and the social media activity may be the response by which the followers that gives us fundamental social media key performance indicators for measuring persuasion. These KPI's then, in turn, help us measure the impact of social persuasion score of that content by a leader on Social media platform™ or other social media platforms.

When a social media leader creates and starts participating in generating awareness such as social aid verification of the account, branding their profile, writing a description, creating a social media platform handle may yield KPI's on impression and reach more followers on and produce a share of Voice (SOV) or Alternatively, top-of-mind awareness (TOM).

A brand is an online persona of a user on a social media platform. The online brand persona of an user will establish the existing role, title, position or influence of the user. The goal for users (acting in the capacity of a campaigner or leaders) on social media platforms (SMP) is to develop an audience online and SMP persona. Personas allow leaders to practice their ability to lead using the follower's sentiment, research, and validation to create an engagement loop and the adoption of more followers. Once leaders get an impression of their target audience and become aware of the optimal time and frequency with which to speak to their audience, they can maximize engagement, SPS and follower trust and loyalty. For example, if a user perceives an online social media brand as more friendly, trustworthy, or desirable copy must include a casual, conversation, or enthusiastic tone.

When a social media leader generates engagement of a target (define) persona audience with content, then the social activity would yield responses and KPIs of the number of engagements. The types of engagement may include: reach of message, the number of messages read, mentions, and hashtags engagements used to calculate the impact of persuasion.

When the social media leader drives the conversion, then the association activity of posts and the social KPIs of the clicks, posts may be used to determine the effectiveness of the persuasion.

When the strategy is to interact with the adoption of customers or users, then the social activity is that of responses specific to them rather and the social KPIS's of earned mentions and positive favorites may create a positive persuasion.

When a social media strategy is to inspire evangelism and target influencers, then the social activity of positive posts, favorites, likes and the social KPIs of the total posts and quotes and mentions that are positive may spark the largest impact of referral activity and positive work of mouth.

Posts can be divided up over the evolution of the timeline. The greater the time a post is on a social media platform, the highest yield it has to strengthen leadership. That content is based on the evolution of their participation. A leader may not be a persuasive overnight. a constant message keeps attracting more and more followers. This “persuasion momentum” is builds over time. The content, however, can be communicated in a number of ways in a post.

A leader may generate a number of types of social interactions. The following are examples of categories of messages:

Text posts: short text messages of text.

Hashtag messages: keywords that people use to find topics on social media.

Link messages: posting a link to a message to indicate a conversation about the post.

Video messages: followers can watch videos and react to them.

Image messages: animated images that allow users to reply and post.

Poll messages are one way to get content ideas from followers. Polls may be taken on a variety of topics from politics to reality shows.

Mention messages may contain a reference to account. (e.g.: “Hello @Social media platformSupport!”)

A leader may engage followers in a number of methods.

The interaction between both these social media nodes of the leader and the follower are defined on their network as the leader is the speaker and the follower being the listener. However, the listener, in this case, can engage in two direct ways to promote the message of the speaker. A leader can strengthen the persuasion factor of their messages by promoting their messages with paid advertisement or choosing to limit their persuasion to a private audience by creating protected messages where your public exposure of posts and mentions is limited.

A post may be shared or repeated. For example, posts in a timeline, a profile, and other profile pages on a social media platform. A comment may be shared directly, or a comment may be shared with an additional comment.

A quoted message may allow one user to quote another message and add a comment.

A protected message may restrict who can see the message. Protected messages may have limited viewing.

Promoted messages are messages where additional viewing has been purchased. Promoted message may be labelled.

A reply message means to reply to a message from another user. A reply is when a response is made to someone else's message. A reply is associated with the original message.

A direct message is a type of reply that can only be sent to one of your public followers.

Every message has a structure. Within that structure lies clues on the impact of that message. To uncover and dissect the architecture of a message there are at least three components: language, social, and emotional. The study of pyscholinguistics opens up a new field of those processes when applied to social media. A social media leader who messages may have a meaningful impact on their followers if and when they use the right tone. Tone is by definition the voice on how the “character” of your leadership comes through in the words, in the case a message. It is not about what the words but the willingness impression it makes on everyone who reads your message. The text and the tone of voice may create a feeling of the leader's impression. The tone of a message may be communicated and may include all the words used in the message. Tone directs the listener to react in a certain manner to a message in a way that gives the leaders a unique voice. The tone may give a recognizable voice establishing a creditability of brand that allows the listener to identify with.

Use of tone is about using language to give a number of messages their own distinct and recognizable voice creating a pattern of consistency that followers can identify with. This consistency may create a social media pulse of content. Social media pulse may be a content that continues to influence and empower followers on a consistent frequency. Control of tone may be what creates the social media pulse. When and how to use it in sending a message. Patterns in social media may provide information about text, structure, and tone. The engagement of the followers determines the response of behavior from that message. In turn gives us the persuasive factor of the message. A message creates a sentiment which in turn, influences others and empowers a catalyst of change for others to take action based on the sentiment being positive, negative or natural.

Many leaders today don't use tone but rather create social media noise. When they place content with a variety of inconsistent tones, that may create confusion between messaging and purpose of their content. This is called Social media noise. Social media noise is content placed online that has no clear tone or purpose of its messaging. When social media leaders are able to embrace a tone they are able to persuade followers to take action and engage with them more affectively. This may create more influence for the leader. This may create a more powerful impact of the message for the leader.

The tone may be used to help tie in the content or text in a unique fashion that the reaction of the listener can change its emotional state by a single message. Tone of voice may be important to a leader's ability to persuade its audience. These patterns of tones can create patterns of the impact fullness of persuasion based on the engagement of that tone in the message and its tie to followers. The tone of a message can create a brand so that the leader's personality is recognizable to a target audience. This recognition may yield their sentiment to the leader's text in a way that makes them emotionally relate to their leader. When a leader uses tone and not the tone of third parties, advertising agencies, or third parties they may be able to distinctively connect with their listener to be more uniquely persuasive and not considered just a generator of social media noise. A feedback loop may be created when a leader uses the right tone and the audience reacts to that tone. The audience may then respond by sentiment and responds in their own tone. This may create a feedback loop that creates an organic momentum of social media pulse which in essence may help a post viralize. Diversity of content can trigger emotion and reach across all personas of the audience that becomes the leaders reach. This creates popularity of the content. This in the social media when multiplies by engagement can trigger viralization of the social feed of the content. Tone also creates a relationship with the leader and follower. It lays down a foundation of character and identity with the leadership establishing power of authority. Social media leadership tone can strengthen the contents clarity and comprehension in a clutter of social media noise. As more content is placed online in the forms of posts the more the leadership may be strengthened by the tone in which they use. This evolution may transform the language and may allow the effectiveness of the leadership to engage with his/her followers.

A leader who embarks on using their voice may, over time, find results of being more effective leader. (message+tone)×engagement=persuasion upon listeners or followers. This shows the audience who you are strategically as a leader, what your message infrastructure is, organizations of your message or messages and how you may communicate a user's personality with his or her followers. The ability to take the message and know that the outcome was successful in engagement merits a return to the account holder as well as to the messenger. This man be done in the following ways:
1. Cryptocurrency
2. Tokens
3. Credits
4. Points
5. Rewards points
6. Swag of services
7. In-kind contributions.
8. Bounties

In each of these 8 ways, a reward can be redeemed for a positive SPS or lost for a negative SPS depending on the desired outcome. A message can take a variety of forms:
1. Content
2. Text
3. Audio
4. Video
5. Virtual Reality
6. Mobile
7. Emojis (are graphics)
8. Emoticons (are pictorial symbols that represent facial expression that a user uses on a messaging platform to express emotion through using characters symbols).
   Content is the written, text, picture, video, virtual reality, photo, gif, animation, and/or sound that is displayed on the social media networks that humans are interacting in. Message is the result of the act of posting content. A social media participant generates a message, and the content of that message is displayed as a post within a social media platform. The interactions with this content is known as a form of engagement. Social media engagement is measured by analytics. But with vast amounts of data of content, it is nearly possible to know what is working and what is not. This apparatus will aide in solving this challenge and enable users to produce, measure, manufacture, synthesis, artificially create, suggest, and/or recommend engaging content by generating it in a real time, stored, application interface, cloud, mobile, laptop, desktop, tablet, virtual reality device and/or computer machine.

The outcome of persuasion can see be seen by:
1) Converting fiat into a currency
2) A marketplace exchange
3. E-commerces
4) Website services
5) Third party websites
6) Form of swaps for swag or other items

Tone structure in social media may be measured a number of different metrics. A message might contain several urban social media abbreviations that signify an expression in a form that can only be made using social media language or lingo. For example, abbreviations such as B4 means before, or LOL means laugh out loud. Word length, sophistication, nuance and popularity also serve as measures of lingo, especially. Shorter words can be more forceful and harder while longer words can be softer and more relaxed. Sentence length can also give shorter posts a concise or informal style or longer ones a more formal or dignified style. Word and sentence length can be measured with a letter and word count. The rhythm of a sentence also serves as a tone metric and signifies the tempo and frequency in which key words are stated in a given sentence. The use of keywords, then creates a pulse of ebb and flow. A word database may be assembled out of key words. Pronoun placement and usage may also serve as metrics and can be measured with names of places or things. For example, first person implies an immediately and personal positioning oneself to a group of people while third person more abstract detachment from followers. The use of jargon or specialized language specific to a particular professional domain like law, finance, politics, or engineering, is also a tone metric. (e.g.: Blue Dog Democrat, Dixicrat, False Consciousness, Kerratic or Yellow Dog Democrat.) Buzzwords are jargon terms that attract novelty are key words that are trending at that time. Clichés are words or phrases in a post that become worn out or overused. Where once fresh and unique words in the messages. The system may measure how often a user uses contractions, diction and colloquialisms as a metric under lingo. The system may measure and suggest against the use of obscure words that few people understand. Mistakes in grammar and misspelling may also be measured along with the use of emoticons, in frequency and type to interpret and relay specific meaning to an intended audience.

Social media platforms may evolve with technology. As social media platforms are exposed, developments may adapt this technology and invention to change.

The system may match tone to match a desired persona. Each audience targeted can be approached by targeting culture, customs, and even social currency. The etiquettes of social media influence perceived appropriate messages. The culture is based on where the message is targeted and which colloquialism, figures of speech or metaphors may be used.

The system may also incorporate the tone of others and give credibility to a message by mentioning another person as an authority or timely response to a reputable fact or figure. Utilizing someone else's tone to be embraced as your own is not only a high compliment to the original author or speaker of that message, but a way to give a message with more credibility by creating a brand. It is important that the tone be understood by the persona being targeted.

The system may analyze a sample social media posts from a single user or group of users and then may grade those posts with a SPS; the system may then compose new messages based on suggested content, and a third party, may then use the system to post content on behalf of the single individual or a group of individuals wherein the content may be predicted to have the same or similar tone as the social media content published by the single user or group of users.

The tone analyzer will convey a speaker's intended attitude or stance for a message. Tone volume is adjusted to two main groups: audience and the situation. So, the content of a message and how it is said can be different when audience personas or situations are different.

Tone is affected by pulse or the frequency of the content deployed over a period. Sentiment is a reaction from the listener (follower) and the situation the speaker writes by choosing the words and sentences to convey tone. Tone can be informal, formal, logical, emotional, intimate, distant, serious or humorous. The sentiment is the inclination of the listener's opinion of the content. which can be positive, negative, or neutral and is evident in the brand reception, rant detection, popularity, perception, or reputation. The system analyzes sentiment to identify the polarity of the audience's reaction to the content and informs the speaker of how engaging a message is relative to the impact of the speaker's tone in order to help a speaker communicate more persuasively to followers or to be empowered to take action.

The tone may be calculated by the structure of the content. Content can consist of text that is long, short, complex simple or a combination of anyone of them. The social media leader tone generator will help suggest tonality, lingo, pulse and sentiment for speakers to use in the messages that they communicate to followers so that their message is more persuasive engaging.

The system interprets, measures and generates a tone that adapts and changes to suit the audience and the situation based on the user's preferences and selected options (e.g.: business entity speaker, intended audience, joyful tone, positive sentiment, optimal positive engagement, celebratory situation).

The system also accounts for the use of pitch in language as a metric of tone to distinguish lexical or grammatical meaning—that is, to distinguish or to inflect words. All verbal languages use pitch to express emotional and other paralinguistic information and to convey emphasis, contrast, and other such features in what is called intonation, but not all languages use tones to distinguish words or their inflections, analogously to consonants and vowels. Languages that do have this feature are called tonal languages.

A social media platform itself can also be programmed to trigger persuasion when the leader engages with the right tone when he evokes engagement and influence over that same network. A leader on such a platform can take a chain approach to tone to reach followers based on a distributed and decentralized communication model that shifts power back to the follower. This social media leader personality or voice, embraces a mental model that is open, on a distributed social media platform (social media platform) and can record his/her communication (posts) between two parties: that of a leader and that of a follower.

Leaders are struggling to keep up with the changes of technology and innovation to communicate with followers effective and their organizations demand no less. Many leaders have avoid the unknown and do not embrace technology as part of their leadership style especially because technology may be unfamiliar to them, not easy to learn or navigate. This invention helps leaders rely on mental models and on technology as a tool to help leaders effectively communicate and engage with followers.

A persuasion metric or score can give insights by showing optimal tone, pulse, relevance, lingo and sentiment to for optimal engagement. Social media systems thinking can best illustrate this is the art and science of making reliable inferences about online behavior within social media networks by developing an increasingly deep understanding of underlying technology, User (UX) Interface, and digital design infrastructure. Cultivating this knowledge of likes, post, leads to the routine use of RIGHT mental models that see the Internet world as a complex system whose SOCIAL behavior is controlled by its dynamic structure, which is the way its feedback loops interact to drive the system's behavior/user.

Social Media Systems thinking is the first visible step in system dynamics which may eventually lead to similar models of this invention for each major social media platform like Facebook™, Social media platform™, Instagram™, LinkedIn™, YouTube™, Google+™, and even Snapchat™.

Social media platform™ may be used as an example. The two variables of Internet Population (the posts) and Social Media Activity (engagement) form a feedback loop. The third variable, internet penetration, is a constant. The population is what is called a “stock,” so it is a box. It accumulates what flows into it minus what flows out of it. In this case, there is only flow into Population, the straight arrow. The little valve icon is a rate; it equals Population multiplied by the Social Media Activity.

The ecosystem of Social media platform or what is known as the Social media platformsphere, is a microblogging service for users to post or message other users about any topic within a 140-character limit and follow others to receive their posts. The inventor conducted the first quantitative study on the entire Social media platformsphere and the social media relationship between a leader and followers impact of tone upon its value to influence other followers to create a feedback loop of engagement causing persuasion and that study, which is pending completion and publication, is a significant basis for this invention and is incorporated herein by reference pending. By looking at psycholinguistics the system finds the right words to express what a message. That interaction with those words is measured in three categories: conversations, amplification, and applause. Each of these classifications creates a total engagement score that is part of the SPS. Conversation rate (CR) may be the number of posts (t) divided by the number of comments (c) or t/c=CR. Amplification rate (AmR) may be the number of posts divided by the number of reposts or t/rts=AmR. Applause rate (ApR) may be the number of post divided by the number of favorites (hearts) or t/fvs=ApR.

The dynamic decision for a leader to engage with its followers in a persuasive matter is proven by his/her presence on the social media platform. This formulation of creating awareness is the first step. The second step is the introduction to the social community by brand, discovery or interruption by the content or the leader's voice. This is the beginnings of the “persuasion loop” (helps determine the score) that then leads to the evaluation step where the leader engages with other experts, reviews feedback and looks at word of mouth (WoM) of responses based upon the content. Then, the leader must leverage this self-expression and interaction of feedback in the form of replies and mentions, which is pure reciprocity, to what is the leader's tone with his or her follower. In this way, leaders are developing an audience online with their social media platform persona that the leader is resonating with. Based upon these interactions leaders use the practice using their social media voice and have instant validation of positive engagement and persuasion so they adopt more and more followers. This is the exercise phase of persuasion where leaders get a sense of the social media pulse of their audience. As a result of strategic targeting and practice with using social media voice, a leader is able to build loyalty that is divided into friends and foes. Friends are loyal advocates who tent to have positive sentiment and commitment toward the leader's messages. Foes are passive listeners who tend to have neutral or negative sentiment and no commitment to the leader's messages. In either case, the leader is establishing a stronger bond with the audience that leads to the audience's willingness to allow the leader to use their content, tone, and engagements with the right sentiment and causes followers to take action or calls to actions which can create a persuasive metric, called the SPS.

Social media culture gives value to engagements to create social media currency that, in turn, allows users to adopt social media customs to be more persuasive.

The social media customs, culture, and currency of any group can cause changes in engagements and their more multiple affects on the tone of the leaders use. Social network analysis (SNA) is the process of investigating social structures through the use of networks and graph theory. It characterizes networked structures regarding nodes (individual actors, people, or things within the network) and the ties, edges, or links (relationships or interactions) that connect them. These ties between each node are cause a culture of engagement, and the currency is the value of each of these engagements. The total reach of a social media platform (technology, ranking, and innovation) in a culture is the value ranking of the central tendency of the mode of that platform's use within that geographical culture. Social Network Theory is the study of how people, organizations or groups interact with others inside this network. Understanding the theory is easier when you examine the individual pieces starting with the largest element, which is networks, and working down to the smallest element, which is the actors the leaders and follower relationship. The exposure, feedback, engagement (connecting) and exchange (sharing) that Social Media platforms provide, creates major changes for the traditional communication models and understandings. Essentially, information flow is no longer considered one-way in which the audience received messages through the “I post—you follow” mantra. Rather, social media integration is seen as an interactive process that enables same-level information exchange among the audience and the leader, creating a long-lasting feedback communication process that gives the leader a total engagement approach or value. Creating in essence, a numerical value for each of these exposures, feedback, engagement, and exchange creates a social media currency that is leveraged to create influence.

Social currency is a common term that can be understood as the entirety of actual and potential resources, which arise from the presence in social networks and communities, may they be digital or offline. The social capital is the cultural or economic capital from the social networks that are marked by a transaction of reciprocity (favorites or reposts) or mentions not mainly for themselves for the common good.

This invention identifies and defines followership and engagement as forms of social capital and provides for a cryptocurrency exchange system for followership and actual engagement.

This social capital helps a leader reach an optimal SPS by triggering conversations and other forms of engagement within the leader's network of followers. These social customs then can take this currency and convert it into a pattern of behavior that helps a leader use their tone to be persuasive with their culture. Persuasion may be divided into triggers, emotions, public persuasion, practical value, and stories.

Triggers are what users think of first in association to a message. Emotions are topics users care about. Public persuasion is when language and behaviors change to conform with others. Practical value means items sent to assist others. Stories are tales told for entertainment.

This message may help any leader viralize, spiralize their message the act of sharing an internet content so many times on social networks that it becomes persuasive.

The “Social media platformism Effect” happens when speech and thought process or intention are different. Messages read might not be the truth. Followers are affected by the conflicting messages so users develop mistrust for what they read.

Social media is has emphasized follower-centric leadership. This crowd power mobilized can create positive or negative change. That change threatens leaders who do not participate in this loop of social freedom of speech; this is social mediocracy. Social mediaocracy is the philosophy that society governs the rule of liberty for followers to express themselves freely and the rule of the majority of followers is to engage independently without the impact of prejudice by a virtuous leader.

The apparatus creates a map of users in a number of social networks. First, users configure their place on the social media platform (establishing their avatar), then find the ability to find the right social media dynamic alignment. This alignment occurs when their online and offline message is the same tone in terms of competency and capabilities. Second, leaders understand that there is a need to create a new identity on social media and can embrace their capabilities of producing content with the tone of voice. Third, leader can amplify a conversation by the distributing it among different channels of technology like a laptop, mobile, television, tablet and social media platforms to create a momentum of applause through likeability. The leaders who align with this dynamic (amplification, conversation, and likeability) may also ideally correspondingly increase what the performance of the linguistic demands based on audience and situation. The more content placed over a period strengthens the tone, and the more technology innovates, the more it may force a leader to creatively generate tone. In both scenarios, leadership may evolve, and tone may evolve as more content and innovations are placed on these social media platforms.

Leaders create feedback loops focused on the world around them and are constantly seeking opportunities to sustain the effectiveness of their tone. They may produce a continuous tone that may change the response of their followers. Because of social media and its decentralized nature and strong shared culture, it is easier for leaders to spot opportunities in the changing world and act proactively and decisively to capitalize on a new design of power via social media. Social mediocracy gives rise to the new model of change and forms a chain of a complex set of connections between leaders and followers: configuration of power, competency of content, and the capabilities of strategic tone.

Purpose and Contributions:

One of the purposes of this system is to create a network that facilitates, stimulates and generates engagement among voters and campaigners on a social media platform specifically designed for voting and campaigning. The purpose of the blockchain system is to make voting, campaigning and cryptocurrency transactions transparent, secure and auditable without compromising voter privacy and without requiring third-party authentication.¹ ¹ Id.

Blockchain will serves four main functions: to store, secure, distribute, and self-execute transactions based on user-participant consensus.

Voting is prohibitively expensive, insecure, and inconvenient and inaccessible in the private and public sectors. This invention would reduce the time needed to vote, register to vote and to tally a vote. Also, voting information is not easily available or accessible. This invention creates one online database with all local, state and federal and international voting and campaigning information. Users will share their true opinions if privacy and compliance exists.

A new wall has been created to respond to persuasiveness looped in repetition or repeal. This loop repeats and profiled feedback. However, a loop's authenticity can be discredited by followers for those who do not learn from others but think for themselves.

Other challenges to establishing persuasiveness are the authenticity and complexity of content and profile communicated by leaders content or followers content. When messages are clustered, speakers have power and the sincerity of sentiment determines this power. Sentiment gives audiences purpose for accelerating engagement which is called virilization.

Leaders must configure themselves to the online environment of social media because the conversation of performance creates value for them. Environmental changes in social media platforms demanded by innovation and by this big data of societies interactions force leaders to find the configuration, capabilities, and competency to persuade their audiences effectively. This invention allows users to become better accustomed effectively using social media in communicating, campaigning and voting.

Power causes reluctance to change. Faster change and increased competition leads to greater overall complexity. Human communication requires ongoing, continuous feedback. Without that ongoing dialogue; society may inevitably drift apart over time when this connection is broken, denoted or distributed. This invention allows for an increased level of meaningful human communication, connection and decision-making.

A campaign's success or failure is built on persuasion. This application shares:
1. Shares an apparatus for persuasion
2. Uses it in a “voting booth” model
3. Measures the Social Media Voice to generate persuasion
4. Applies these measurements to calculate a index of persuasion
5. Rewards persuasion success between author and reader or leader or follower
6. Develops an exchange model to reward both participants based upon these metrics

Usability Sequence, Features and Specifications

Operational Structure. Capabilities: The invention enables users to create an account with six capabilities: to create, (2) maintain, (3) and run an online campaign or voting booth, or both; (4) to redeem Rally Coins for actual engagement of other users (and not by fake accounts or bots); and to redeem (5) Social Media Tokens by allowing other users to use one's network to influence other users; and (6) to generate a record of every transaction entered into with a service provider or other entity involving voting or campaigning with metadata in tact. The invention stimulates user engagement via:
Push notifications
Location-based search and campaign suggestions
Map to Visualize Votes
Social Integration
One-click contacting
QR Codes for Campaigns
Mobile
Virtual Reality (can do it through VR system and vote/participate)
Machine learning (process to learn voter and campaign behaviors to be more effective at targeting (more selective)
API connects w/3d party networks

The invention uses blockchain technology to:
create, store, verify and archive an accessible social media repository for campaigning and voting data of users on blockchain;
Provide a database of responsive templates for campaigning, voting, and canvassing: edited with no additional coding with embedded contact information of a user responsible for this account;
placed on a blockchain that stores custom templates under one account;
which notifies all parties about the changes on a particular campaign or voting poll/booth; and certifies each transaction and any change to it on blockchain.
   The invention uses the IBM Watson™ Tone Analyzer and Natural Language Understanding (NLU) as a basis for which to measure tone and sentiment because it demonstrated a high level of reliability and validity according to IMB scholarly research for quantifying other data. Natural language is imputed/data mined into the software algorithms, which recognize features such as punctuation; n-grams (bigrams, trigrams, unigrams); emotions; greetings; curse words; and sentiment polarity to categorize various emotion groupings. Watson™ and NLU provide unique analyses of tone and sentiment. They each have distinct algorithms to predict tone and sentiment accurately without confounding one another.

Each Template may be organized by:
Voting, campaigning or canvassing method or by
Country or
State or
Candidate or
Subject or
Business
and with embedded contact information of a user responsible for this account;
in blockchain that stores custom templates under one account;
and notifies all parties about the changes on a particular campaign or voting booth;
and certify each vote and any changes to it on blockchain

Certified validation of votes on blockchain in a “Click to blockchain” web browser plugin and integration on Campaigning and Voting Terms and Services Agreement (“TSA”) page in the Voterspace system:

When someone clicks on the terms and services, this will save every transaction into their account and certify it to block chain for any third party.

First, the blockchain invention identifies and saves the date, time geolocation, IP address and biometrics of users each time they enter into campaign or vote (“transaction”). The blockchain stamps this metadata onto the face of the document. Then, the system certifies the validation of the transaction and preserves the original transaction in storage on the blockchain. Users will have the option of downloading, printing or sending the transaction to another location. The system stores updated or modified transactions as separate transactions from the originals but associates them with the corresponding older and original transactions in the blockchain for convenience.

The invention enables users to create an archive with the option to save documents to a private or public blockchain authorized by the blockchain or subchain number securing the hyper-ledger or third party authorization. This is the certification component. Signatures on the blockchain will be done by three nodes: (1) The party signing; (2) Voterspace which is certifying it; (3) and the third party delivering it to or any combination thereof. Users have the option to not use the blockchain when signing their agreements but they do so at their own risk. This system:
1. would no longer keep power over transactions in the hands of the webmaster;
2. and would make updates to changes in a campaign, poll or booth available to users in a content feed;
3. and would rely on intelligence on website in form of analytics'
4. and would give users the ability to monitor, track and interact with an audience in a secure, encrypted form so that the information is date, time, geolocation and biometrically stamped, automatically archived and can be sent to others via email, and/or in the form of SMS. Whoever contacts the user and any message and metadata sent will be archived at the time and date they were contacted. All TSA documents, campaigns and vote booths will also receive an identification number. Any version of them will be stored and blockchain certified.

Once someone automatically interacts with the form or has agreed to the TSA, if the user's TSA changes, the notification system of the engine of Voterspace will automatically send a notification to users about any TSA updates.

Account Types. A user can either create a free individual account or purchase a premium account. An individual account holder can create a personal profile, privately or publically vote in a campaign, associate with another user or campaign, respond to and/or like a campaign or other user's discussion about a campaign. A user's profile consists of a section for the user's name, photo, tag line, links to associated social media, and the cities or groups in which the user has a high and low vote; a section that is an engagement board for discussions with other users, a section for a biography and a section for voting. The voting section contains a click-to-vote button, the amount of time left for voting and amount of votes tallied for the day and in total. An individual account holder can pay a fee to upgrade to a campaigner account.

A campaigner account holder can create and/or publish campaigns to other users in their network. A campaigner account holder can: invite other users to associate, vote and/or participate in a campaign; limit a vote to be public or private; and can directly or indirectly broadcast a campaign. A campaign account holder can indirectly broadcast a campaign by submitting a request to another user to campaign on the other user's social network in exchange for Rally Coins. The user can choose to accept or decline the offer. If the recipient accepts the offer, the recipient may redeem Rally Coins if the campaigner account holders' use of the user's social network yields an increase in actual engagement. Actual engagement consists of a vote, meaningful reply or share of the campaign but not likes.

This invention enables users who upgrade to a premium account for a fee, the option to update their social media, voting, campaigning or privacy policy terms agreement to comply with the laws of the user's jurisdiction.

Votes, leaders, rankings, positions between leaders and followers can almost be gamified so users know where they stand in terms of status on a leader board and can be assigned to a account so users and VSP knows who is and who is not effective.

The system is designed to entertain and help increase participation but not to be used to affect the outcome of a legitimate governmental campaign unless it is certified by the government authority and in compliance with the laws and regulations of that entity.

Voter-Campaign Search Engine. The system will contain a Voter-Campaigner search engine that enables users to find all available and relevant campaigns to vote on. Campaigners or voters with a premium account can request search engine optimization (SEO) to enables other users to find their campaigns or campaign content organically, whenever other users type keywords into the search engine. Users can conduct a search for campaigns or campaigners by typing keywords or phrases into the search engine. Then, the search engine will algorithms to arrange the by relevance and popularity and then ranked according to topical authority from branded content to naked URLs for optimal quality in search results.

Compliance Engine. Compliance engine that tells users what they must adhere to: (e.g.: restrict IP addresses; provide an existing voter database list of only guaranteed voters; restrict voting to registered voters whose identities have been authenticated and verified based on list of registered voters and biometrics or other identifying information; a specific time in which the campaign can be run then has to be shut down. The engine allows for coordination government owned and operated third-party databases that can even reside on their servers.

The unofficial campaigns will not require use of the compliance engine. These campaigns are linked by key words and tags, so users can find like-minded users or campaigns and Artificial Intelligence will tell the sentiment of those like the user or not like the user. Users can find other campaigns to support their campaign and share opinions openly or anonymously while influencers can track the sentiment, tone, pulse, and lingo of campaigns to gauge engagement effectiveness via existing social networks.

Voting systems recognized by the invention include but are not limited to:
First Past the Post
Single Transferable Vote
Additional Member System
Alternative Vote Plus
Two Round System
Alternative Vote
Supplementary Vote
Borda Count
Party List Proportional Representation
Dual Member Proportional² ² Electoral Reform Society, Types of Voting System, (https://www.electoral-reform.org.uk/voting-systems/types-of-voting-system/).

Voting types recognized by the invention include but are not limited to:
Polls
Push
Tracking
Exit
Straw
Surveys (cross-sectional, longitudinal, individual or group-based)
Questionnaires (e.g.: Market Research, employee or customer satisfaction and evaluations)
   Interviews
Crossover
Prospective
Retrospective
Split or Straight Ticket
Straight, Cumulative, or Majority

Examples of campaign types recognized by the invention include but are not limited to:
Political
Marketing
Elections
   Shareholder voting
      Board of Directors
         Nominate, elect, remove
      Corporate documents (bylaws, etc.)
         Review, amend, inspect
      Mergers, Acquisitions, Dissolution
         Amend, inspect
   Nonprofit
      Board of Directors
      Get out the vote
   Political Elections
      Presidential Primary
      General Election
      Nominate, elect, remove candidates for office

Examples of voting ballots recognized by the invention's digital voting booths:
“Paper” Ballots (Digital)
Punch Cards (Digital)
Marksense (Optical Scan)
Direct Recording Electronic
Hand Count of Digital ballots (manually by a user)

Crypto, Exchange and Wallet Model:

Then content and engagement goes into the blockchain, which is private or public. Actual engagement is rewarded with Rally Coin cryptocurrency then accessed through the cryptocurrency exchange. Use of social media network can be purchased for Social Media Token cryptocurrency then accessed through the cryptocurrency.

Description of Figures:

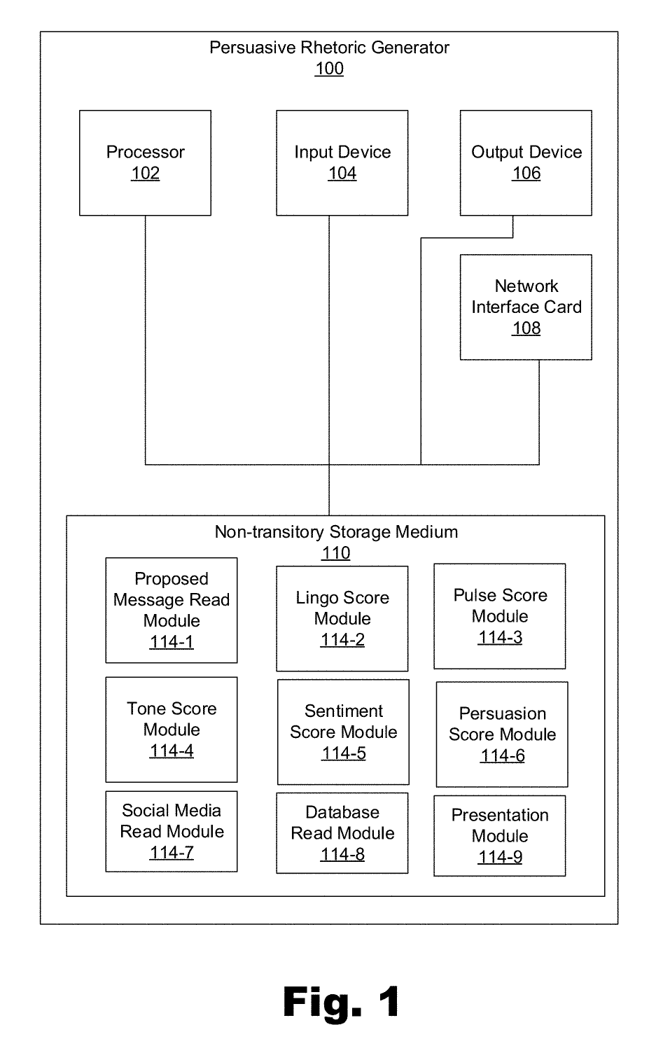

Referring now to the figures, FIG. 1 illustrates a persuasive rhetoric generator (100). The persuasive rhetoric generator (100) includes a processor (102), and input device (104), and output device (106), a network interface card (108), and a non-transitory storage medium (110).

The processor (102) causes the persuasive rhetoric generator (100) to perform a particular task. The processor (102) may execute a number of instructions stored in the non-transitory storage medium (110) to cause the persuasive rhetoric generator (100) to perform a particular task.

The input device (104) may receive input from a single device, such as a keyboard, or from a number of devices, such as a computer mouse, a touchscreen, a microphone, or a biometric reader. The input device (104) allows a user of the persuasive rhetoric generator (100) to provide instructions to the persuasive rhetoric generator as to what it should do. The input device (104) may receive input of a message that the persuasive rhetoric generator (100) may evaluate for a social media participant.

An output device (106) provides the persuasive rhetoric generator (100) a means whereby it can provide information to the user of the persuasive rhetoric generator (100). The output device may be a computer screen, a touchscreen, an audio output device, or other means to impart language and data to the user of the persuasive rhetoric generator (100).

The network interface card (108) may allow the persuasive rhetoric generator (100) to interact with other computing devices. The persuasive rhetoric generator (100) may interact with a nether computing device that contains a database of information harvested from social media networks. The information in the databases may be partially processed to enable the persuasive rhetoric generator (100) to efficiently search and process the information. The network interface card (108) may allow the persuasive rhetoric generator (100) to interact with a number of social media networks. The persuasive rhetoric generator (100) may interact with the social media networks both by reading post of a variety of social media participants, or directly posting a message from the user of the persuasive rhetoric generator.

The non-transitory storage medium (110) may store computer code instructions that instruct the processor (102) to cause the persuasive rhetoric generator (100) to perform a particular task. The non-transitory storage medium may consist of a computer hard drive or other types of mass storage devices. The non-transitory storage medium may include a number of modules (114).

The number of modules (114) cause the persuasive rhetoric generator (100) to perform a particular task. Though modules are illustrated as to the purpose and task the module may perform, modules may be combined, or may be divided into multiple steps, and remain consistent with the principles disclosed herein. The modules may contain software instructions, computer hardware, or a combination thereof

As illustrated, the non-transitory storage medium (110) contains a proposed message read module (114-1), a lingo score module (114-2), a pulse score module (114-3), a tone score module (114-4), a sentiment score module (114-5), a social persuasion score module (114-6), a social media read module (114-7), a database read module (114-8), and a presentation module (114-9).

The proposed message read module (114-1) causes the persuasive rhetoric generator (100) to read a proposed message from an input device (104). The proposed message may be a message, such as a post, that the user of the persuasive rhetoric generator (100) wishes to post on a social media network. The proposed message read module (114-1) may read a proposed message from an audio input device and use voice to text translation to create a text-based message.

The lingo score module (114-2) may examine the contents of the proposed message to evaluate and score the language use within the proposed message. The lingo score module (114-2) may measure the linguistic lingo of a number of proposed messages based on the use of emojis, hashtags, mentions, post urls, abbreviations, emoticons, emojis, capitalization and punctuation. The lingo score module (114-2) may compare the linguistic usage within the proposed message against the linguistic usage of a number of social media post. The number of social media post may represent a target audience for the proposed message.

The pulse score module (114-3) examines the frequency of messages of a user of the persuasive rhetoric generator (100). The pulse score module (114-3) may examine the frequency of messages from other users of the social network, including other influential leaders, participants, or followers of the user of the persuasive rhetoric generator (100). The pulse score module (114-3) may examine the frequency of post over a particular time period.

The tone score module (114-4) may examine and score the tone of the message including a message type, intensity, category of tone, and sentiment of a number of proposed messages of a producing speaker to a target audience. The tone score module (114-4) may categorize the message into a tone type or provide a numeric score evaluating the tone of the proposed message.

The sentiment module (114-5) scores the sentiment of a proposed message. The sentiment may measure the direction, emotion, characteristics, and user information of a message to determine a direction and the direction of a and the number of previously published messages. The sentiment module may, for example, determined that a proposed message deviates from the pattern of messages and the consistency of those sentiments.

The social persuasion score module (114-6) may combine the output of the lingo score module (114-2), the pulse score module (114-3), the tone score module (114-4), and the sentiment score module (114-5) to create a social persuasion score representing the effectiveness of each of a number of proposed messages so that the user of the persuasive rhetoric generator (100) may select a message that is persuasive to the target audience and continues with the desired message of the user of the persuasive rhetoric generator (100).

The social media read module (114-7) may read a number of messages shared by a number of different users on a number of different social media networks to inform the persuasive rhetoric generator (100) of the lingo, poles, tone, and sentiment of other users of social media networks both before and after the persuasive rhetoric generator (100) post a message from the user of the persuasive rhetoric generator (100).

The database read module (114-8) may read information regarding social media posts from a database. The database may include a number of raw social media posts, or it may include a number of partially processed social media posts that may be used in identifying the lingo, pulse, tone, and sentiment of a number of social media users targeted by the user of the persuasive rhetoric generator (100).

The presentation module (114-9) presents the social persuasion score to the user of the persuasive rhetoric generator (100). The presentation module (114-9) may also present the lingo score, the pulse score, the tone score, and the sentiment score. Additional scores, layout, and functionality may be presented as part of the presentation modules (114-9) activities.

And over all example according to FIG. 1 may now be given. A user uses the persuasive rhetoric generator (100). The proposed message read module (114-1) causes the processor (102) to read a proposed message using the input device (104) from the user of the persuasive rhetoric generator (100).

The persuasive rhetoric generator (100) may use a social media read module (114-7) in the database read module (114-8) to provide information to evaluate the proposed message.

The lingo score module (114-2) may identify a score for the lingo used in the proposed message comparing the lingo to known quantities, including the data read from the social media read module (114-7) and the database read module (114-8).

The pulse score module (114-3) may measure the frequency of posting over a period of time to identify if the user of a persuasive rhetoric generator (100) is posting too frequently or too infrequently to be persuasive with their target audience.

The tone score module (114-4) measures the tone of a number of proposed messages by comparing those messages with the data retrieved from the social media read module (114-7) and the database read module (114-8).

The sentiment score module (114-5) measures the sentiment of a proposed message using the social media read module (114-7) and the database read module (114-8). The sentiment may be identified to match a number of social media users or may be selected to alter the tone and sentiment of a discussion.

The social persuasion score module (114-6) may use the output of the lingo score module (114-2), the pulse score module (114-3), the tone score module (114-4), and the sentiment score module (114-5) to identify a single score representing the persuasion level of a number of proposed messages.

The social media read module (114-7) may read posts from the user of the persuasive rhetoric generator (100) and other users to inform the persuasive rhetoric generator (100) of the lingo, pulse, tone, and sentiment of the conversation within social media.

The database read module (114-8) may read posts that have been stored in a computer database from the user of the persuasive rhetoric generator (100) and other users of social media networks to inform the persuasive rhetoric generator (100) of the lingo, pulse, tone, and sentiment of the conversations within social media.

The presentation module (114-9) may present the scores generated by the social persuasion score module (114-6), the lingo score module (114-2), the pulse score module (114-3), the tone score module (114-4), and the sentiment score module (114-5) to inform the user of the persuasion factors related to a number of proposed messages.

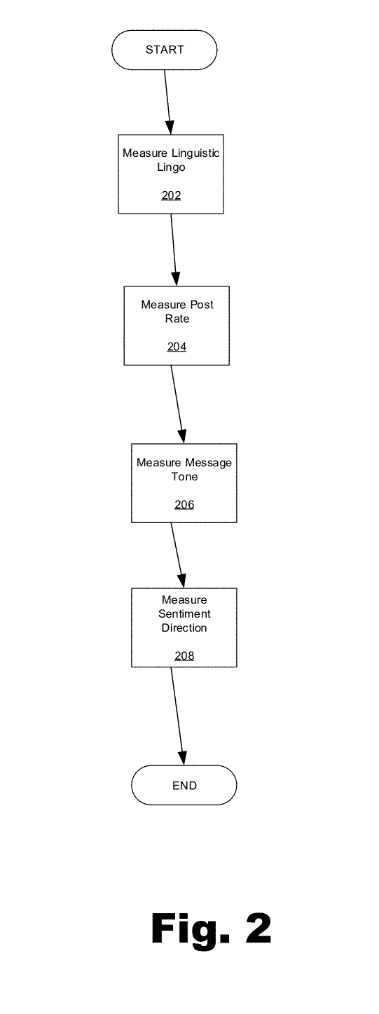

FIG. 2 represents a method (200) for generating persuasive rhetoric for a social media participant. The method (200) includes measuring linguistic lingo (202), measuring pulse rate (204), measuring message tone (206), measuring sentiment direction (208), and identifying a social persuasion score (210).

Measuring the linguistic lingo (202) measures the word selection, emoticons, emojis, and selection of idea expressing symbols as compared to existing conversations and education levels. For example, an overly wordy and complex message may be ineffective at communicating an idea to a group of teenagers interested in music. The same message, however, may be effective in communicating with an academic audience. In another example, a trendy post full of emoji's and emoticons may be effective with a young audience, however they may be ineffective with an academic audience.

Measuring the pulse rate (204) measures the frequency of messages compared to the attentiveness of the audience. A high pulse rate may indicate that messages are not being seen or are not effectively communicating with the target audience. A high pulse rate may indicate that messages are being discarded. A low pulse rate indicates that the audience is not receiving frequent enough messaging so as to keep the speaker in the mind of the audience. A pulse rate that is effective may have a resonant effect with the audience so as to amplify the message being presented well keeping the speaker in the mind of the intended audience.

Measuring the message tone (206) measures the tone of the message compared to the target audience. For example, the tone of the message to a religious audience may be less confrontational then the tone of the message to an audience preparing to protest for a cause.

Measuring a sentiment direction (208) examines the emotional attributes of a message and compares them to the emotional desires of the target audience. For example, an auto mechanic audience may be less interested in emotions and more interest in factual presentations of information. However a different group may be more affected by emotions as may be seen in the public dialogue for that different group.

Calculating a social persuasion score (210) may include combining the linguistic lingo, pulse rate, message tone, and sentiment direction to determine the amount of persuasiveness of a set of particular messages. By a user consistently optimizing the persuasiveness of their messages the user can increase their stature and influence. In a political situation, the user may be able to influence voters to vote for them by being a more effective persuader.

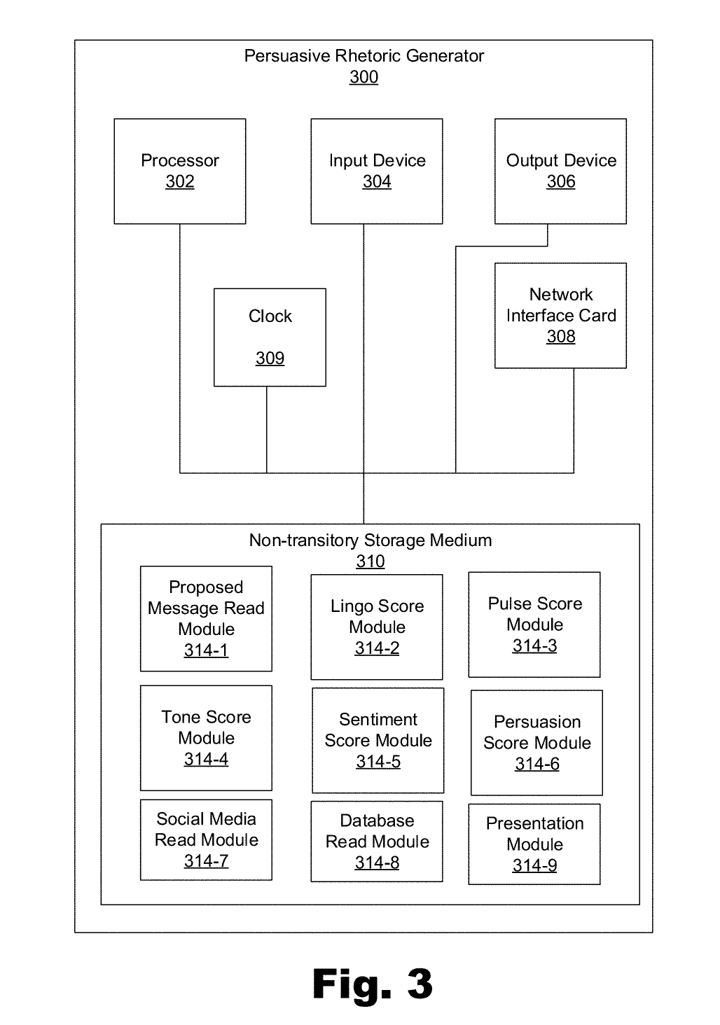

FIG. 3 represents a persuasive rhetoric generator (300) according to one example of the principles described herein. The persuasive rhetoric generator (300) may include a processor (302), an input device (304), an output device (306), a network interface card (308), a clock (309) and a non-transitory storage medium (310).

As described above, the non-transitory storage medium (310) may include a number of modules that cause the processor (302) to cause the persuasive rhetoric generator (300) to perform a particular task. As illustrated the modules include a proposed message read module (314-1), a lingo score module (314-2), a pulse score module (314-3) a tone score module (314-4), a sentiment score module (314-5), a social persuasion score module (314-6), a social media read module (314-7), a database read module (314-8), and a presentation module (314-9).

As illustrated, the pulse score module (314-3) may use the clock (309) to measure the amount of time between messages, or the frequency between the messages that are shared. This may allow the user of the persuasive rhetoric generator (300) to send messages at a frequency that may resonate with a number of individuals that are in the influence of the persuasive rhetoric generator. The residents may increase the effectiveness of the user of the persuasive rhetoric generator so as to increase the persuasive factor of that speaker and the rhetoric they use.

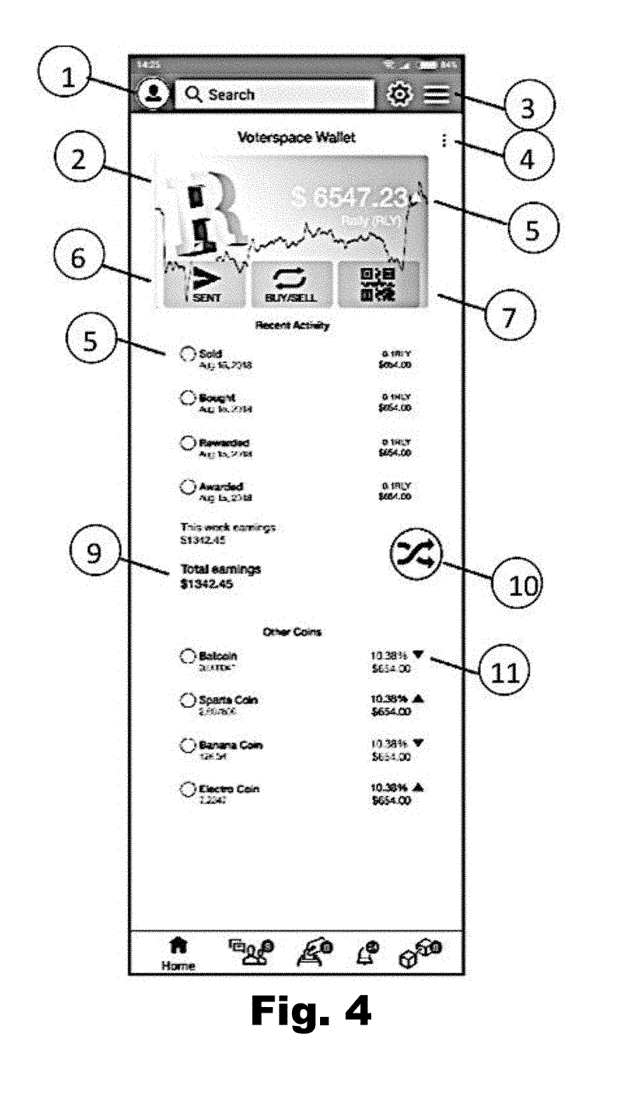

FIG. 4 represents an embodiment of an interface to encourage participation in a survey or election. A header (1) with link to personal profile with image, search box and other options. Crypto exchange status bar (2) is displayed with action buttons, showing exchange rate history. Link (4) to additional options, with drop down menu. Link (4) to contact or join an organization may be displayed. Crypto-token exchange rate (5) based on user's fiat currency preference may be shown. Buttons (6) providing options to send crypto-tokens to reward services or donate to campaigns allow a user to interact with a survey or election. Options to buy/sell crypto-tokens on cryptocurrency exchanges may be used. QR scan code for crypto-token wallet may be shown to communicate with other uses, or identify a survey or campaign. Summary of crypto-token activity (5), summarizing sold, bought, rewarded, and awarded crypto-tokens may be shown. Summary of total earnings in USD. Illustration of weekly earnings. Selecting text can provide additional options for earning analytics vs. time or specific campaigns. Button (10) to crypto-token exchange and analytics page. Exchange rate information (11) on crypto coins may be shown.

FIG. 4 additional Description:

| | |
|---|---|
| 1. | Header with link to personal profile with image, search box and other |
| | options. |
| 2. | Crypto exchange status bar with action buttons, showing exchange |
| | rate history. |
| 3. | Link to additional options, with drop down menu. |
| 4. | Link to contact or join organization. |
| 5. | Crypto-token exchange rate based on |
| | user's fiat currency preference. |
| 6. | Buttons providing options to send crypto-tokens to reward services or |
| | donate to campaigns. Options to buy/sell crypto-tokens on crypto- |
| | currency exchanges. |
| 7. | QR scan code for crypto-token wallet. |
| 8. | Summary of crypto-token activity, summarizing sold, bought, |
| | rewarded, and awarded crypto-tokens. |
| 9. | Summary of total earnings in USD. Illustration of weekly earnings. |
| | Selecting text can provide additional options for earning analytics |
| | vs. time or specific campaigns. |
| 10. | Button to crypto-token exchange and analytics page. |
| 11. | Exchange rate information on crypto coins. |

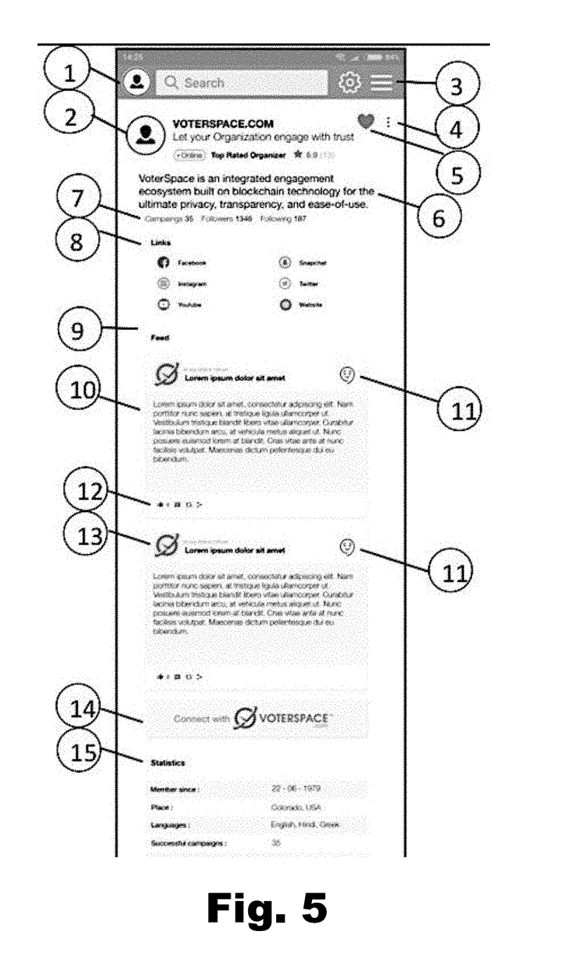

FIG. 5 represents another participation interface. A header (1) with a link to personal profile with image, search box and other options is shown. Link (2) to image of an organization is shown. Link may open a more detailed organization page. A link (3) to additional options is shown and may display drop down or other means. A link (4) for more actions regarding organization, contacting organization, or becoming a member of that organization is shown. A love button (5) allows user likes the work and value that influencer provides. A short mission statement (6) or summary of organization is shown. Additional information may be available upon tapping on the text. Organization status update (7) is shown including campaigns, followers or members, etc. Additional links (8) to social media profiles may be shown as available. Organization's feed (9) including feedback and recommendations from verified members or followers that are involved with the organization. Feedback may be anonymous provided that terms of use are not violated. Sentiment analysis (10) is shown and may be based on actual campaigns where the person providing feedback and the influencer were involved. A user may have the option to provide personal feedback (11) by user utilizing promoter's services. Additional feedback options (12) such as like feedback or positive feedback indicators on comments are shown. Additional comments (13) or feedback similar to items 9, 10, 11 may be available. Options (14) to connect to the organization as a follower or sign-up to become regular member are shown. Organizational information (15), including area of operations, area of expertise or interest, age, activity. Individual items could be provided as links to highlight further organizational activities.

FIG. 5 Additional Description:
1. Header with link to personal profile with image, search box and other options. (1)
2. Link to image of an organization. Link may open a more detailed organization page. (2)
3. Link to additional options, with drop down or other means. (3)
4. Link for more actions regarding organization, contacting organization, or becoming a member of that organization. (4)
5. Love button if user likes the work and value that influencer provides. (5)
6. Short mission statement or summary of organization. Additional information may be available upon tapping on the text. (6)
7. Organization status update, including campaigns, followers or members, etc. (7)
8. Additional links to social media profiles may be available. (8)
9. Organization's feed including feed back and recommendations from verified members or followers that are involved with the organization. Feedback may be anonymous provided that terms of use are not violated. (9)
10. Sentiment analysis for based on actual campaigns where the person providing feedback and the influencer were involved. (10)
11. Personal feedback by user utilizing promoter's services. (11)
12. Like feedback or positive feedback indicators on comments. (12)
13. Additional comments or feedback similar to items 9, 10, 11. (13)
14. Option to connect to the organization as a follower or sing-up to become regular member. (14)
15. Organizational information, including area of operations, area of expertise or interest, age, activity. Individual items could be provided as links to highlight further organizational activities. (15)

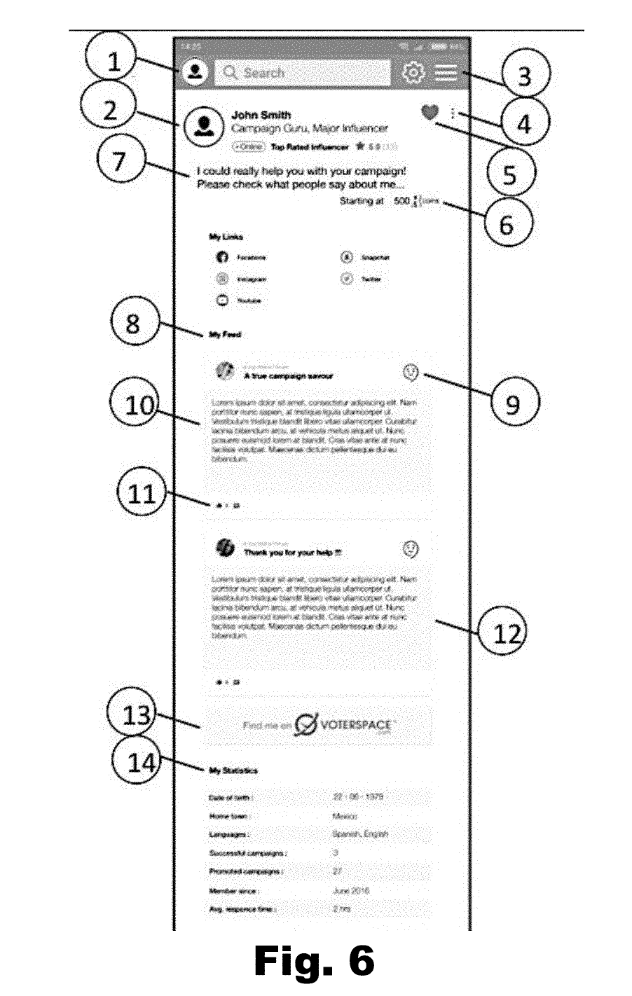

FIG. 6 represents another participation interface. Header (1) is a link to personal profile with image, search box and other options. Link (2) is a link to image of an influencer. Link launches profile view of influencer. Header may include information about network value of influencer. Link (3) is a link to additional options, with drop down or other means. Link (4) is a link for more actions regarding campaign, or contacting campaigner. Love button (5) is used if user likes the work and value that influencer provides. Influencer (6) is a cost for starting crypto token fees for promoting content or campaigns. Personal summary (7) is how an influencer can assist campaigns, personal note. Clicking could allow a user to expand the personal note with more information. Additional links to social media profiles may be available. Personal influencer feed (8) may include feedback and recommendations from verified campaigners that utilized the influencer's promotion services. Sentiment analysis (9) may show actual campaigns where the person providing feedback and the influencer were involved. Personal feedback (10) allows a user to utilize a promoter's services. Like (11) allows feedback or positive feedback indicators on comments. Like (12) feedback or positive feedback indicators on comments. Additional comments (13) may allow feedback similar to items 9, 10, 11. Option (14) to contact influencer or find activities of influencer within platform are allowed. Personal influencer information (15), including area of operations, area of expertise or interest, age, activity. Individual items could be provided as links to highlight further activity based on influencer's privacy settings are shown.

FIG. 6 Additional Description:
1. Header with link to personal profile with image, search box and other options.
2. Link to image of an influencer. Link launches profile view of influencer. Header may include information about network value of influencer.
3. Link to additional options, with drop down or other means.
4. Link for more actions regarding campaign, or contacting campaigner.
5. Love button if user likes the work and value that influencer provides.
6. Influencer starting crypto token fees for promoting content or campaigns.
7. Personal summary of how influencer can assist campaigns, personal note. Clicking could expand the personal note with more information. Additional links to social media profiles may be available.
   8. Personal influencer feed including feed back and recommendations from verified campaigners that utilized the influencer's promotion services.
   9. Sentiment analysis for based on actual campaigns where the person providing feedback and the influencer were involved.
   10. Personal feedback by user utilizing promoter's services.
11. Like feedback or positive feedback indicators on comments.
12. Like feedback or positive feedback indicators on comments.
13. Additional comments or feedback similar to items 9, 10, 11.
14. Option to contact influencer or find activities of influencer within platform.
15. Personal influencer information, including area of operations, area of expertise or interest, age, activity. Individual items could be provided as links to highlight further activity based on influencer's privacy settings.

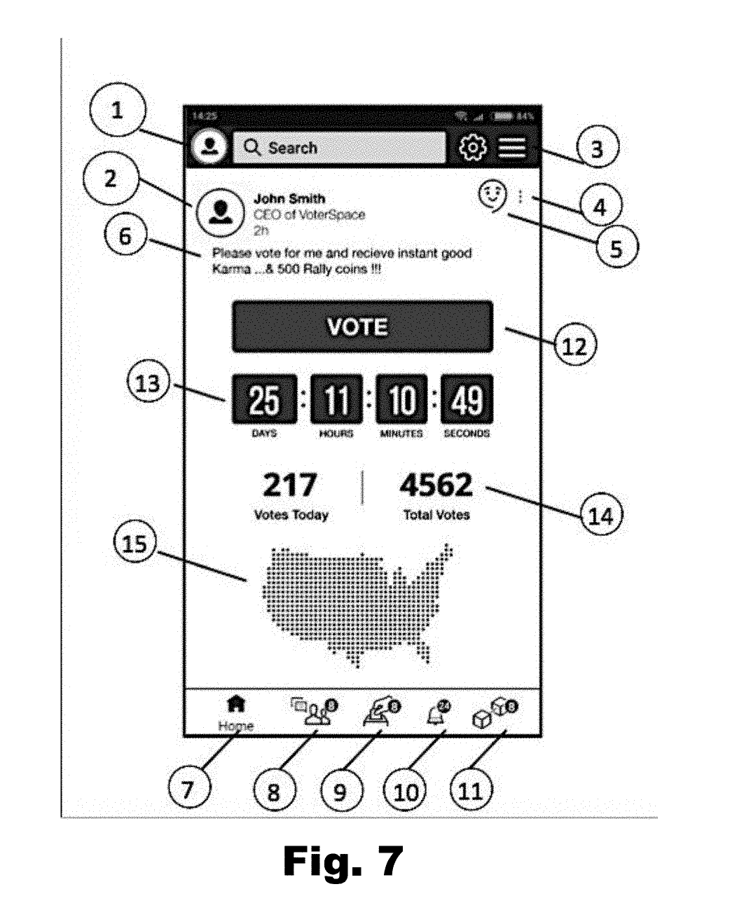

FIG. 7 represents an interface for allowing survey or voting. Header (1) with link to personal profile with image, search box and other options is shown. Link (2) to image of a campaigner is shown. Link launches profile view of campaigner. Link (3) to additional options, with drop down or other means. Link (4) for more actions regarding campaign, or contacting campaigner. Dominant (5) sentiment analysis icon is shown. Selecting the icon launches further artificial sentiment analytics and options. Messaging (6) for individual campaign, with possible rewards in crypto tokens shown. Link (7) back to home is shown, also refreshes auto-feed content on page. Link (8) to connection requests and messaging with notifications for number of messages or connection requests are shown. Link (9) for campaigns requesting user to vote notification on the number of campaigns requesting participation. Notifications icon (10), considering all notifications, are shown. Notifications (11) regarding block-chain crypto token rewards and awards may be shown. Voting action (12), launches voting options are shown. Voting options may appear on the same screen as an expanded menu option or by other multiple choice selection options. Time remaining (13) until end of campaign may be shown. Vote tracking notification bar (14) including total votes, votes today, with possible rollovers displaying positive or negative votes based on segment analysis (by region, or other criteria) is shown. Clicking on a number may offer additional campaign analytics options. Geolocation campaign analytics (15) offering overview of voting progress based on voter location or registered location may be offered. Clicking on map may launch a more detailed geolocation analytics page.

FIG. 7 Additional Description:

Header with link to personal profile with image, search box and other options (1).

Link to image of a campaigner. Link launches profile view of campaigner (2).

Link to additional options, with drop down or other means (3).

Link for more actions regarding campaign, or contacting campaigner (4).

Dominant sentiment analysis icon. Selecting the icon launches further artificial sentiment analytics and options (5).

Messaging for individual campaign, with possible rewards in crypto tokens (6).

Link back to home, also refreshes auto-feed content on page (7).

Link to connection requests and messaging with notifications for number of messages or connection requests (8).

Link for campaigns requesting user to vote notification on the number of campaigns requesting participation (9).

Notifications icon, considering all notifications (10).

Notifications regarding block-chain crypto token rewards and awards (11).

Voting action, launches voting options. Voting options may appear on the same screen as an expanded menu option or by other multiple choice selection options (12).

Time remaining until end of campaign (13).

Vote tracking notification bar including total votes, votes today, with possible rollovers displaying positive or negative votes based on segment analysis (by region, or other criteria). Clicking on a number may offer additional campaign analytics options (14).

Geolocation campaign analytics offering overview of voting progress based on voter location or registered location. Clicking on map may launch a more detailed geolocation analytics page (15).

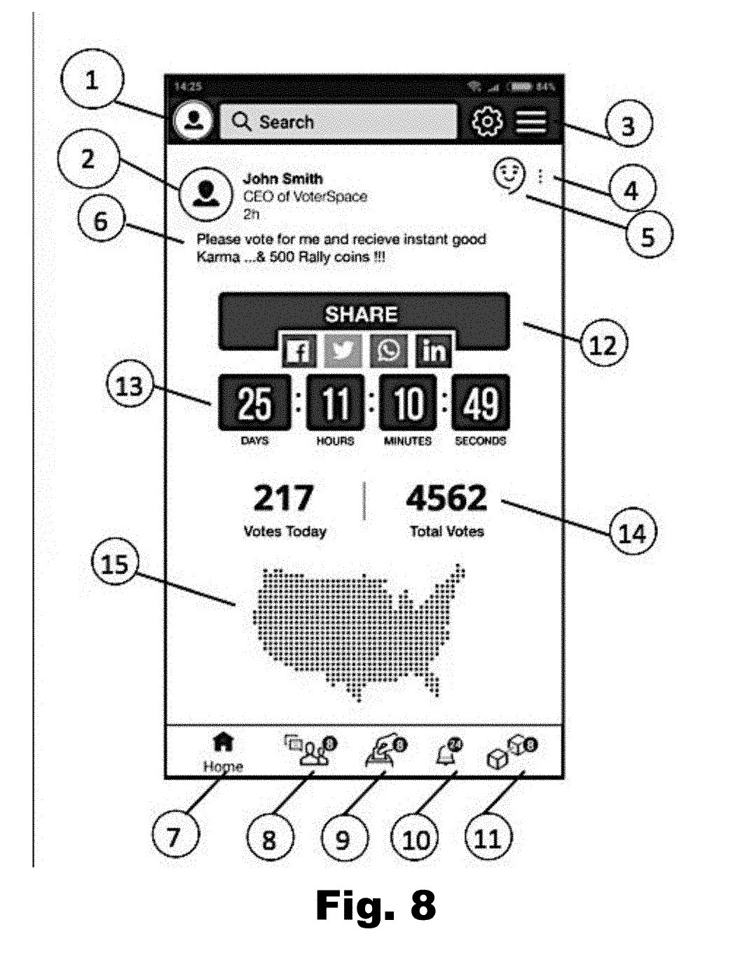

FIG. 8 is an interface for a user to share a poll or election. Header (1) with link to personal profile with image, search box and other options. Link (2) to image of a campaigner. Link launches profile view of campaigner. Link (3) to additional options, with drop down or other means. Link (4) for more actions to campaign, or contacting campaigner. Dominant sentiment analysis icon (5) Selecting the icon launches further artificial sentiment analytics and options. Messaging (6) for individual campaign, with possible rewards in crypto tokens. Link (7) back to home, also refreshes auto-feed content on page. Link (8) to connection requests and messaging with notifications for number of messages or connection requests. Link (9) for campaigns requesting user to vote notification on the number of campaigns requesting participation. Notifications icon (10), considering all notifications. Notifications (11) regarding block-chain crypto token rewards and awards. Option for sharing campaign (12) on other social media. Time remaining (13) until end of campaign. Vote tracking notification bar (14) including total votes, votes today, with possible rollovers displaying positive or negative votes based on segment analysis (by region, or other criteria). Clicking on a number may offer additional campaign analytics options. Geolocation campaign analytics (15) offering overview of voting progress based on voter location or registered location. Clicking on map may launch a more detailed geolocation analytics page.

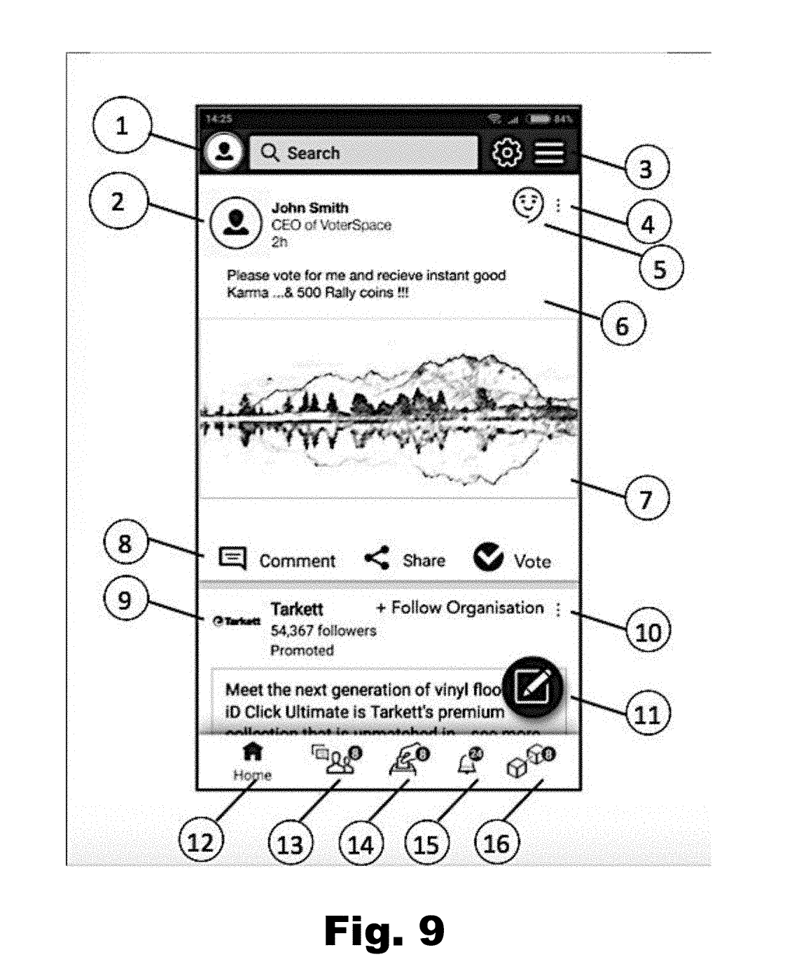

FIG. 9 shows a speaker listing of a poll or election. Header (1) with link to personal profile with image, search box and other options. Link to image of a campaigner (2). Link launches profile view of campaigner or influencer. Header could also include overall network value rating for influencer. Link to additional options (3), with drop down or other means. Link for more actions (4) regarding campaign, or contacting campaigner. Dominant sentiment analysis icon (5). Selecting the icon launches further artificial sentiment analytics and options. Messaging (6) for individual campaign, with possible rewards in crypto tokens. Link back to home (7), also refreshes auto-feed content on page. Link to connection requests (8) and messaging with notifications for number of messages or connection requests. Link for campaigns (9) requesting user to vote notification on the number of campaigns requesting participation. Notifications icon (10), considering all notifications. Notifications (11) regarding block-chain crypto token rewards and awards. Interactive holder (12) for images, videos, or other shareable rich media. Place holder (13) for selecting to comment, share, or vote on campaigns. Individual buttons may be dynamically changing between different options when user scrolls through the individual comment, share, or vote buttons. Promoted organization profile page (14) on personal feed. Display of organization page to be based on targeting criteria and individual user profile settings. Additional options (15) for following organization, examining organization activities, registering to become a member, expressing sentiment etc. Create campaign or discussion button (16). Button launches a new page where the user can create their own campaign or discussion topic.

FIG. 9 Additional Description:

Header with link to personal profile with image, search box and other options (1).

Link to image of a campaigner. Link launches profile view of campaigner or influencer. Header could also include overall network value rating for influencer (2).

Link to additional options, with drop down or other means (3).

Link for more actions regarding campaign, or contacting campaigner (4).

Dominant sentiment analysis icon. Selecting the icon launches further artificial sentiment analytics and options (5).

Messaging for individual campaign, with possible rewards in crypto tokens (6).

Link back to home, also refreshes auto-feed content on page (7).

Link to connection requests and messaging with notifications for number of messages or connection requests (8).

Link for campaigns requesting user to vote notification on the number of campaigns requesting participation (9).

Notifications icon, considering all notifications (10).

Notifications regarding block-chain crypto token rewards and awards (11).

Interactive holder for images, videos, or other shareable rich media (12).

Place holder for selecting to comment, share, or vote on campaigns. Individual buttons may be dynamically changing between different options when user scrolls through the individual comment, share, or vote buttons (13_.

Promoted organization profile page on personal feed. Display of organization page to be based on targeting criteria and individual user profile settings (14).

Additional options for following organization, examining organization activities, registering to become a member, expressing sentiment etc. (15).

Create campaign or discussion button. Button launches a new page where the user can create their own campaign or discussion topic. (16).

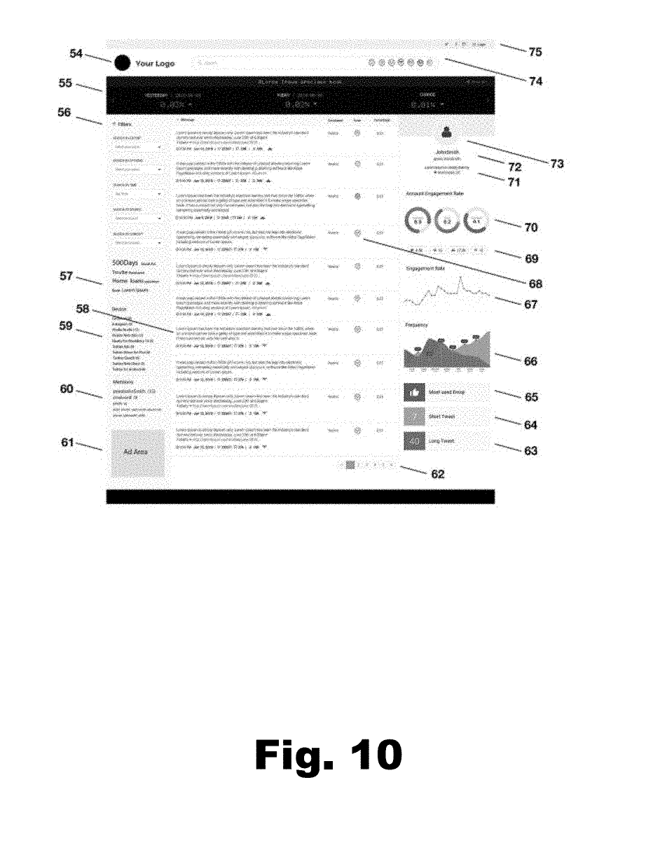

FIG. 10 represents an interface for monitoring rhetoric. Profile Icon/Photo; Profile Settings (54). Profile Image (55). Welcome Text (56). Social media interaction buttons (57). Organization, Group, Subgroup Logo (58). Home Screen Tab (59). All about Social Engagement Tab and Messaging Functionality (60). Voting, All about Campaign Tab (61). All Notifications Tab (62). Crypto Wallet, Exchange, Blockchain Tab (63). Create New Campaign Button (64). Options per feed and (b) Follow Organization Buttons. Photo uploaded (65) from user included in feed. Emoticon/Sentiment (66). User Profile Options (67). APP Settings (68). APP Main Menu (69), other Functionalities like camera etc. Welcome Text (70), Subject of Campaign. Remaining time (71) until end of campaign. Voting map (72). Votes Today (73) and Total votes for current campaign. Vote button (74), when clicked becomes Share. Main display area (75) for Crypto currency info.

FIG. 10 Additional Description:

Profile Icon/Photo, Profile Settings (54).

Profile Image (55).

Welcome Text (56).

Social media interaction buttons (57).

Organization, Group, Subgroup Logo (58).

Home Screen Tab (59).

All about Social Engagement Tab and Messaging Functionality (60).

Voting, All about Campaign Tab (61).

All Notifications Tab (62).

Crypto Wallet, Exchange, Blockchain Tab (63).

Create New Campaign Button (64).

Options per feed and (b) Follow Organization Buttons (65).

Photo uploaded from user included in feed (66).

Emoticon/Sentiment (67).

User Profile Options (68).

APP Settings (69).

APP Main Menu, other Functionalities like camera etc (70).

Welcome Text, Subject of Campaign (71).

Remaining time till end of campaign (72).

Voting map (73).

Votes Today and Total votes for current campaign (74).

Vote button, when clicked becomes SHARE (75).

Main display area for Crypto currency info (76).

In some embodiments an interface for order processing is used which may contain: a Crypto Rate diagram fluctuation updated in real time; Exchange activity of crypto coin and relevant amount for every activity (awarded is coin collected from award system, rewarded is amount of coin sent to influencers for services); a This week earnings section; and Total earnings of crypto activity; Other coins section, crypto coins in our wallet section; Current price of crypto in exchange platform (down arrow means is falling) section; Exchange button which takes you to exchange area, depending on if you are a user or an organization; Popular buttons for crypto exchanges, Sent, Buy/Sell, QR scanner for faster sending coins.

In some embodiments an interface may display:
Current price of crypto coin in dollars or other currency;
Successful campaigns of organization executed, Followers, Following: how many the organization is following;
Social Media Networks with relevant numbers of Friends, Followers or Subscribers according to social network platform given data;
Main text of feed, can be private (blurred) or public;
Action Bar: Like, Share, Comment Buttons with last comment displayed and emoticon with sentiment percentage; Logo of organization;
Connect with Organization Button, or apply for a connection depending on administrative rights etc;
Analytics for Organization, Group or Subgroup;
Main Subject of feed with date of creation and time;
Welcome text and information about Organization, Group, Subgroup;
Connection state: Online/Offline; Application overall Rate for organizer, SMN rate with star system;
Organization Name with Moto;
Profile image of Influencer.

[symbol]

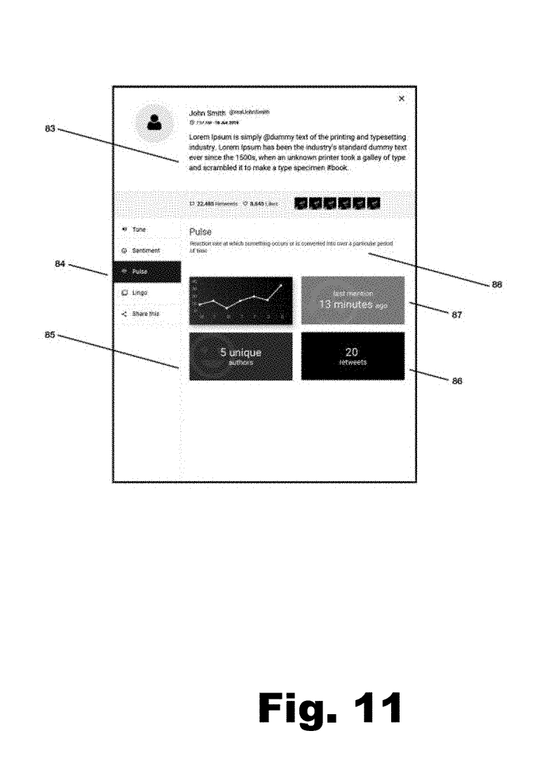

FIG. 11 represents an interface for displaying the output of pulse measuring module; analytics (83) for organization, group, or subgroup; pulse rate (84); number of unique authors (85); number of reposts (86); time interval to most recent last mention (87); definition of pulse (88).

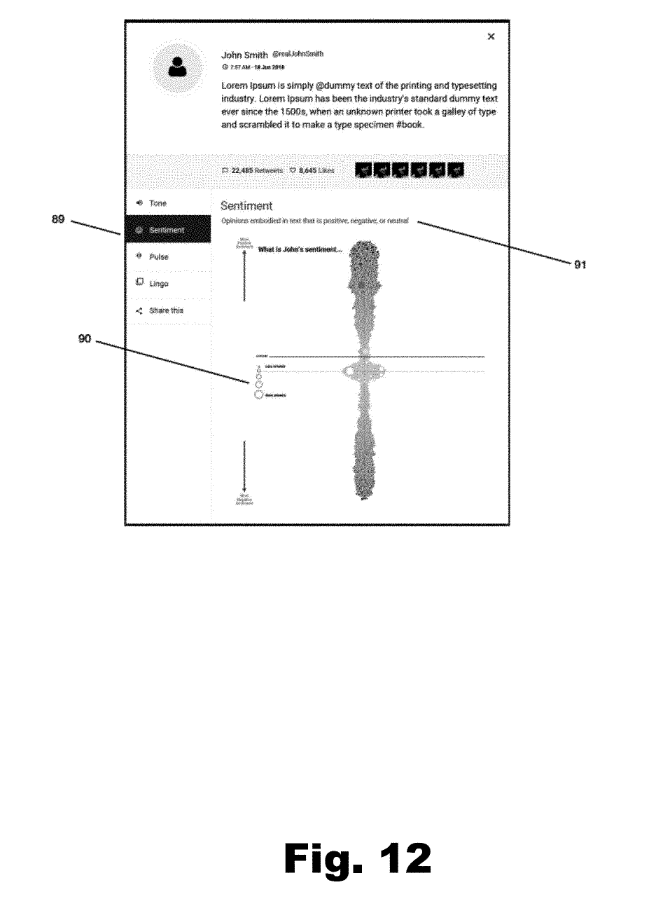

FIG. 12 represents the output of a sentiment measuring module. Main descriptive text (89) for profile. Influencers window (90) of advertising, Feed section with most important feeds selected by the user or AI, Feed can be private or public. Main text (91) of current feed. Graphical representation or scatter plot of sentiment (9100) relative to the number of postings;

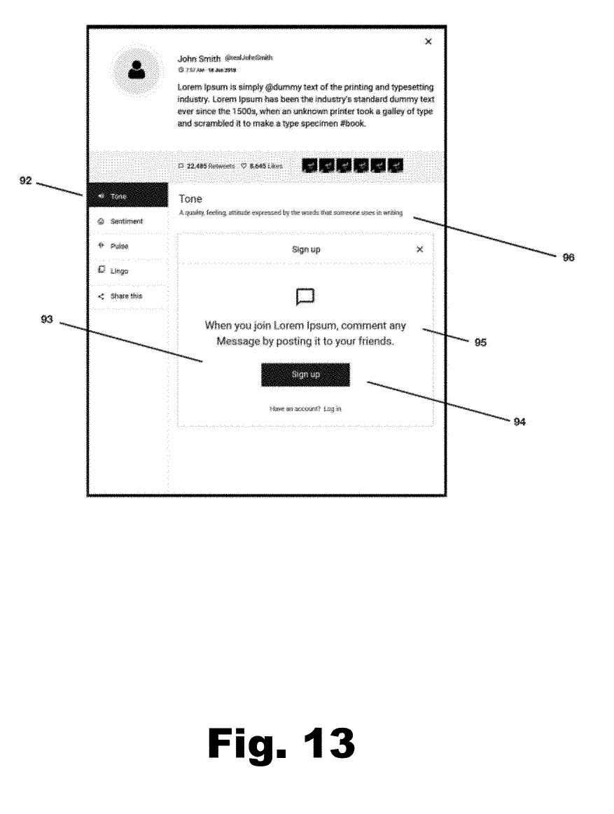

FIG. 13 represents a tone signup interface. Indicator that tone is being displayed (92); sign up box (93); signup button (94); instructions (95); definition of tone metric (96).

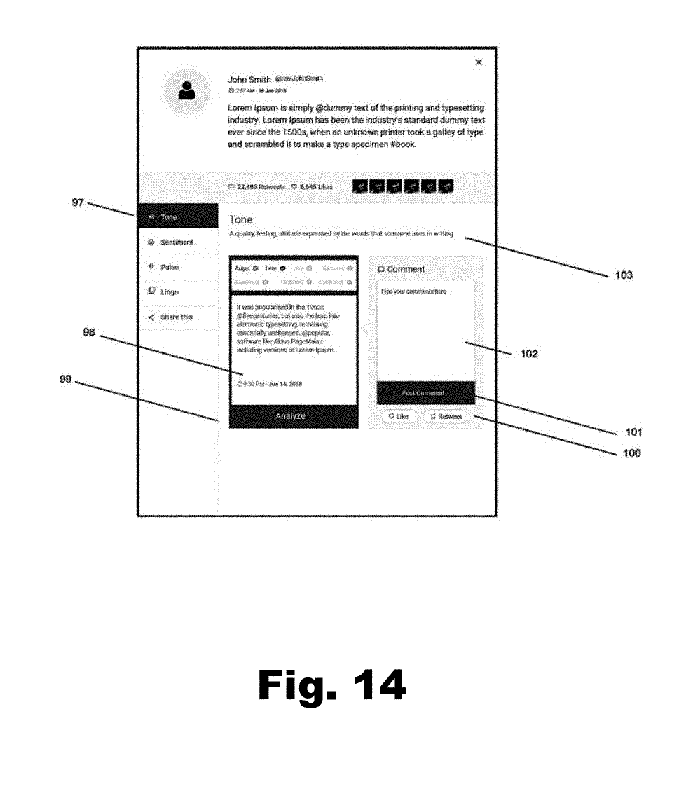

FIG. 14 represents the output of a tone analyzing module; tone tab analyzer tab (97); content of the message that is being analyzed for tone (98); icon button for instructing system to analyze the content of the message (99); reviewers pane (100); post comment button (101); box for entering comments about the message that is being analyzed (102); definition of tone metric (103).

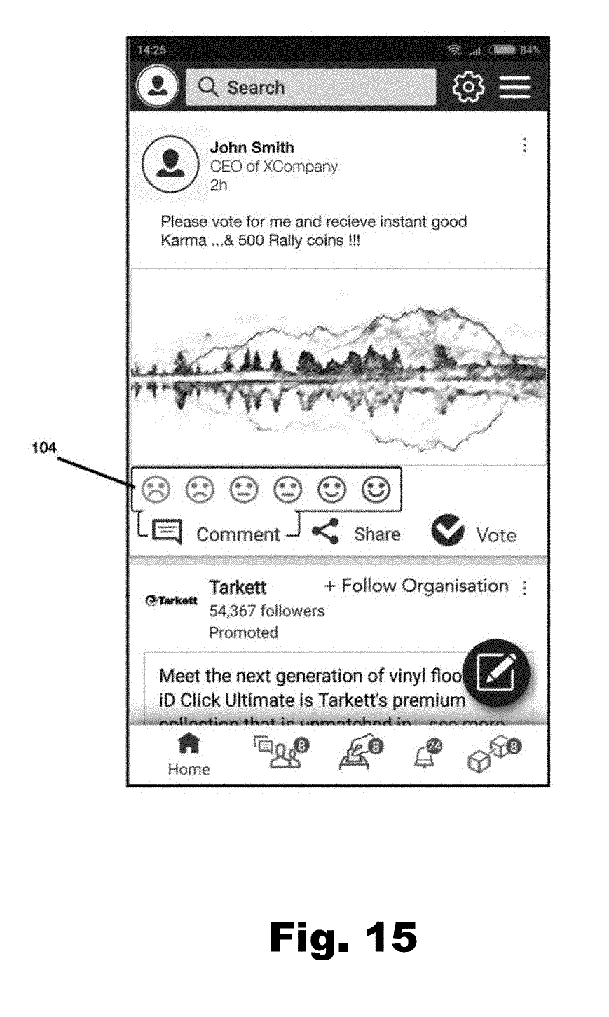

FIG. 15 depicts an expression interface, specifically a sentiment selection tool of an interface; display of types of sentiment ranging from negative sentiment, to neutral sentiment, to positive sentiment (104).

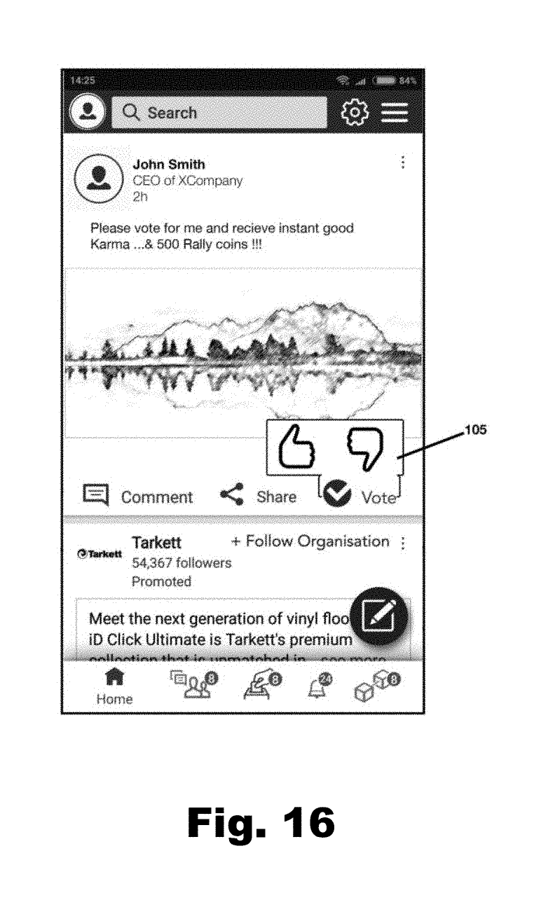

FIG. 16 depicts an expression interface, including a a voting icon of an interface, allowing a user to vote in favor of or against an item.

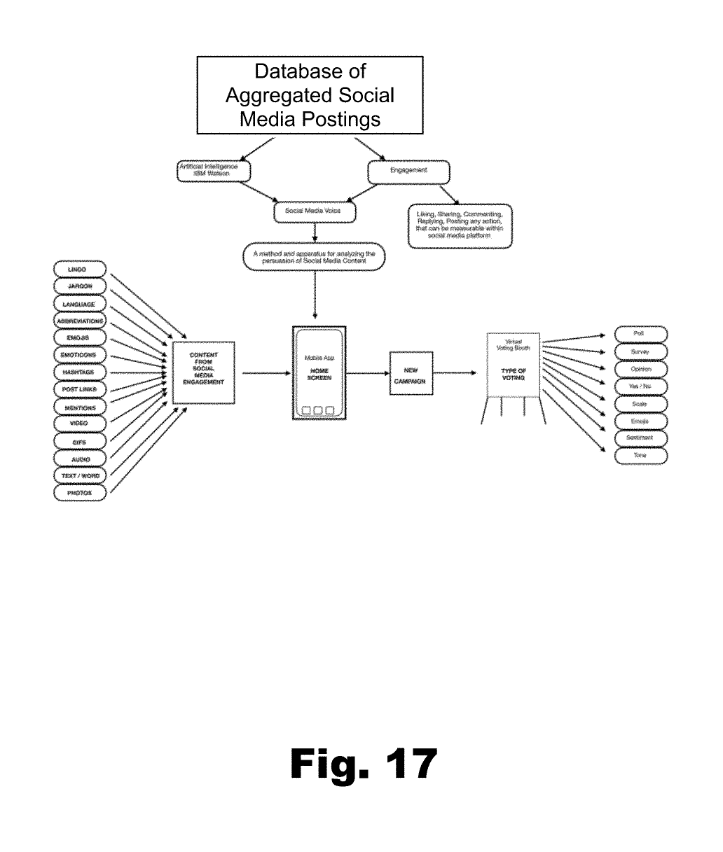

FIG. 17 is a process for creating a campaign, creating a voting booth, or generating persuasive rhetoric;
Content from social media engagement is entered by user into the App. Content includes but is not limited to: lingo, jargon, language, abbreviations, hashtags, emojis, emoticons, poll links, mentions, videos GIFs, text, video, audio, images, timing (pulse, frequency, business, noise), types of campaigns, types of voting booths, types, of tone, branding, sentiment, identity and situation. The app then analyzes the content to obtain the Social Media Voice used for the unpublished content with the IBM Watson Artificial Intelligence Natural Language Processing and Tone Analyzer and provides a unit of measure for each variable (tone, sentiment, lingo, pulse). The app then calculates the current and optimal Social Media Persuasion Score (SPS) for the content. The app then provides suggestions to increase persuasiveness of content based on the optimal SPS score. Suggestions include modifications to content, which type of publication (type of campaign or voting booth) to use, and the rate of publication to use based on the optimal persuasion score. The user can then choose which content to publish based on the improved SPS score. The user can then publish the more persuasive content (which is a voting booth or campaign) at the more persuasive rate in the most persuasive way (type of campaign or voting booth) and receive enhanced engagement for using the suggested and/or modified persuasive content based on the improved SPS score. Enhanced engagement metrics can include increased return on engagement (ROE), return on influence (ROI), return on message (ROM), return on follower (ROF), and return on power (ROP).

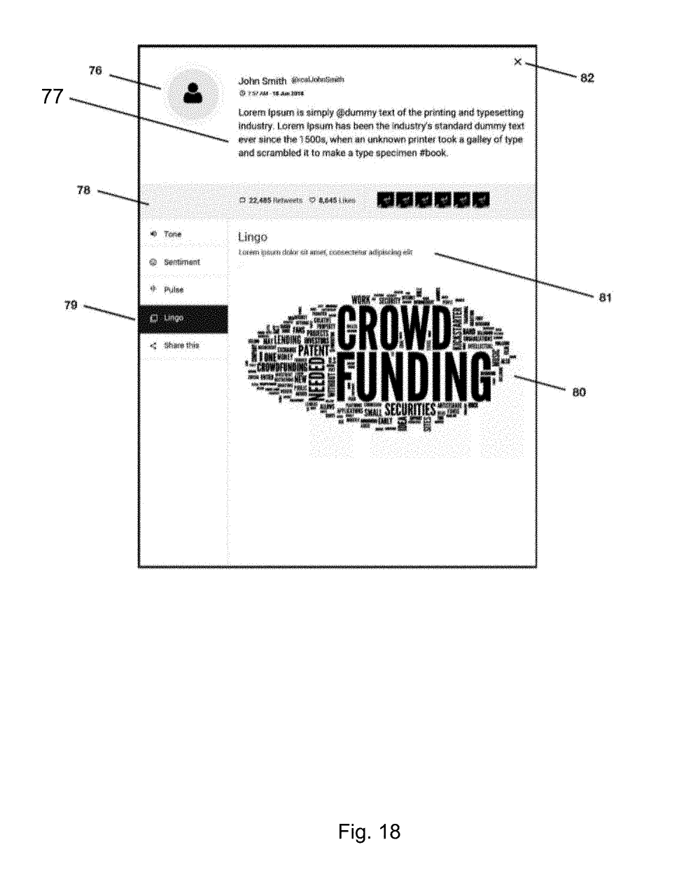

FIG. 18 depicts an interface showing the lingo analyzing tool; it may include a profile picture icon of the user (76); the short description of the profile of the user's profile; amount of engagement and popularity based on reposts and likes (78); lingo score module tab (79); visual map illustrating linguistic expression of a single message; definition of lingo (81); close icon to closeout (82).

The foregoing descriptions of embodiments have been presented only for purposes of illustration and description. They are not intended to be exhaustive or to limit the embodiments to the forms disclosed. Accordingly, many modifications and variations may be apparent to practitioners skilled in the art. Additionally, the above disclosure is not intended to limit the embodiments. The scope of the embodiments is defined by the appended claims.

1. An apparatus to generate persuasive rhetoric for a social media participant (leader or follower) the apparatus comprising:
a processor;
an input device, the input device communicatively connected to the processor, the input device receiving a number of proposed messages;
an output device, the output device communicatively connected to the processor, the output device notifying, a social media participant of a number of metrics regarding the number of proposed messages, and reading, interpreting, analyzing and calculating and predicting the results for SPS;
a non-transitory storage medium, the non-transitory storage medium comprising:
a proposed message read module, the proposed message read module reading a number of proposed messages from the input device;
a lingo score module, the lingo score module measuring the linguistic lingo of each of the number of proposed messages based on the linguistic lingo of a number of previously published messages and assigning a lingo score to the message;
a pulse score module, the pulse score module measuring the frequency of the number of proposed messages with a rate of postings for the number of previously published messages;
a tone score module, the tone score module measuring a willingness attitude of the number of proposed messages; and,
a sentiment module, the sentiment module measuring a sentiment direction and a sentiment direction of the number of previously published messages.

2. The apparatus of claim 1, wherein the lingo score module measures the use of hashtags, mentions, abbreviation, post-links and emojis.

3. The apparatus of claim 2, wherein the non-transitory storage medium further comprises a social persuasion score module, the social persuasion score module measuring changes in a lingo score, a pulse score, a tone score, and a sentiment score based on the posting of a proposed message.

4. The apparatus of claim 1, wherein the number of previously published messages comprises a number of messages published on a number of social media platforms.

5. The apparatus of claim 4, wherein the non-transitory storage medium further comprises a number of post databases, each of the number of post databases containing a number of posts.

6. The apparatus of claim 1, wherein the non-transitory storage medium further comprises a social media read module, the social media read module reading a number of posts from a number of posted messages.

7. A method for generating persuasive rhetoric for a social media participant, the method comprising:
reading a number of proposed messages from the input device;
measuring a linguistic lingo for each of a number of proposed messages based on a linguistic lingo metric of a number of previously published messages and assigning a linguistic lingo score to the message;
measuring a frequency of the number of proposed messages with a rate of postings for the number of previously published messages;
measuring a tone of a message based on a willingness attitude of the number of proposed messages;
measuring a sentiment of a direction based on a number of previously published messages.

8. The method of claim 7 wherein measuring the lingo score further comprises measuring the use of hashtags, mentions, abbreviation, post-links and emojis.

9. The method of claim 8 further comprising measuring a social persuasion score.

10. The method of claim 9 further comprising measuring a change in a lingo score based on the posting of a proposed message.

11. The method of claim 9 further comprising determining a proposed change in a lingo score based on the proposed posting of a proposed message.

12. The method of claim 9 further comprising measuring a change in a pulse score based on the posting of a proposed message.

13. The method of 9 further comprising determining a proposed change in a pulse score based on the proposed posting of a proposed message.

14. The method of claim 9 further comprising measuring a change in a tone score based on the posting of a proposed message.

15. The method of 9 further comprising determining a proposed change in a tone score based on the proposed posting of a proposed message.

16. The method of claim 9 further comprising
displaying a graphical user interface comprising a content feed;
storing voting activities of a user and campaigning activities of a user on an interactive database coupled to a search engine and compliance engine;
generating content according to voting activities of a user and campaigning activities of a user;
wherein one or more items in the content feed is presented to that viewing user, in order of relevance to the viewing user's recent activity;
displaying to a user a link such that when the user clicks on the link the user likes, shares, replies, comments, votes, of abstains from voting; wherein the attached link would allow a viewing user to access one of the items in the feed and interact (engage) with the activity in the form of a like, share, reply, comment, vote or abstention;
presenting a social persuasion score to a user;
receiving a response from the user regarding the user's acceptance or rejection of the social persuasion score;
using an artificial intelligence engine that is coupled to a database library to select at least one alternative message;
recalculating the social persuasion score of the alternative message;
automatically posting the new message when the social persuasion score of the alternative message is greater than the original social persuasion score by a user-selected threshold.

17. An apparatus to measure, analyze and generate persuasive rhetoric for a producing speaker, the apparatus comprising:
a processor;
an input device, the input device communicatively connected to the processor, the input device receiving a number of proposed messages in at least one format of audio, text, video, imagery, photos;
an output device, the output device communicatively connected to the processor, the output device notifying a producing speaker of a number of metrics regarding the number of proposed messages;
a non-transitory storage medium, the non-transitory storage medium comprising:
a proposed message read module, the proposed message read module reading a number of proposed messages from the input device;
a lingo score module, the lingo score module measuring the linguistic lingo of each of the number of proposed messages based on the linguistic lingo metric, including at least one of emojis, hashtags, mentions, post url, abbreviations, emoticons, emojis, capitalization, and punctuation, of a number of previously published messages;
a pulse score module, the pulse score module measuring the frequency of the number of proposed messages over a period of time, with a rate of postings for the number of previously published messages;
a tone score module, the tone including type, intensity, category of tone, the tone score module measuring a willingness attitude of the number of proposed messages;
a sentiment score module, the sentiment module measuring a direction and at least one emotional attribute of a number of previously published messages.

18. The apparatus of claim 16 wherein the linguistic lingo score has a value between zero and one.
